(19) United States
(12) Patent Application Publication
(10) Pub. No.: US 2022/0274202 A1
(43) Pub. Date: Sep. 1, 2022

(54) ADDITIVE MANUFACTURING MACHINE

(71) Applicants: Mazak Corporation, Florence, KY (US); UT-Battelle, LLC, Oak Ridge, TN (US)

(72) Inventors: David A. Wilson, Knoxville, TN (US); Joseph C. McNay, Independence, KY (US); Adam M. McGrath, Erlanger, KY (US); Thomas J. Reckers, Florence, KY (US); Thomas A. Feldhausen, Knoxville, TN (US); Kyle S. Saleeby, Destin, FL (US); Seiichi Hattori, Florence, KY (US); Shunsuke Koike, Florence, KY (US); Masaharu Onji, Florence, KY (US)

(21) Appl. No.: 17/681,708

(22) Filed: Feb. 25, 2022

Related U.S. Application Data
(60) Provisional application No. 63/154,511, filed on Feb. 26, 2021.

(51) Int. Cl. B23K 26/342; B23K 26/211; B23K 9/10; B23K 26/03; B23K 26/00; B23K 9/12; B23Q 5/04; B33Y 30/00; B33Y 50/02; B33Y 10/00; G06T 7/00

(52) U.S. Cl. CPC B23K 26/342; B23K 26/211; B23K 9/1093; B23K 26/032; B23K 26/034; B23K 26/0093; B23K 9/125; B23Q 5/04; B33Y 30/00; B33Y 50/02; B33Y 10/00; G06T 7/0006; G06T 2207/30164

(57) ABSTRACT

An additive manufacturing machine that includes a wire supply including a wire drive configured to advance a wire at a wire feed rate and a wire heater configured to apply resistive heating to heat the wire. The additive manufacturing machine includes an additive head for emitting a laser beam to weld the wire to a substrate, a sensor configured to detect a weld parameter, and a controller operatively connected to the wire supply, additive head, and sensor. The controller is configured to determine a failure mode of the weld as the laser beam welds the wire to the substrate based at least in part upon the weld parameter. In response to determining the failure mode, the controller is configured to adjust at least one of the wire feed rate, the resistive heating, and a power of the laser beam as the laser beam welds the wire to stabilize the weld.

### CROSS-REFERENCE TO RELATED APPLICATION

This application claims the benefit of U.S. Provisional Patent Application No. 63/154,511, filed on Feb. 26, 2021, which is hereby incorporated by reference in its entirety.

### GOVERNMENT LICENSE RIGHTS

This invention was made with government support under CRADA No. NFE-19-07760 between Mazak Corporation and UT-Battelle, LLC, which manages Oak Ridge National Laboratory for the United States Department of Energy. The government has certain rights in this invention.

### FIELD

This disclosure relates to machine tools and, more specifically, relates to machine tools having additive and subtractive capabilities.

### BACKGROUND

Hybrid machine tools are known that permit different types of operations to be performed on a workpiece. For example, some hybrid machine tools facilitate production of a part using additive manufacturing and machining of the part using machine tools. The additive manufacturing operation utilizes a laser that is directed at a bed of particles to fuse the particles together and form the part.

### SUMMARY

In one aspect of the present disclosure, an additive manufacturing machine is provided that includes a wire supply including a wire drive configured to advance a wire at a wire feed rate and a wire heater configured to apply resistive heating to heat the wire. The additive manufacturing machine includes an additive head for emitting a laser beam to weld the wire to a substrate, a sensor configured to detect a weld parameter, and a controller operatively connected to the wire supply, additive head, and sensor. The controller is configured to determine a failure mode of the weld as the laser beam welds the wire to the substrate based at least in part upon the weld parameter. In response to determining the failure mode, the controller is configured to adjust at least one of the wire feed rate, the resistive heating, and a power of the laser beam as the laser beam welds the wire to stabilize the weld. The additive manufacturing machine monitors the welding process via the sensor to detect deviations from a stable welding process and adjusts the wire feed rate, the heater electrical power, and/or the laser power to take corrective action and stabilize the welding procedure. The additive manufacturing machine may thereby dynamically control the operation of the additive head as the additive head welds the wire to the substrate to ensure the additive head builds a workpiece having a predetermined geometry.

In one embodiment, the failure mode determined by the controller comprises any one or more of a plurality of predetermined failure modes including excessive arcing, non-linear wire feed, sagging of an additive surface, and inadequate bead penetration into the substrate. The controller may determine the failure mode upon the weld parameter approaching an upper or lower threshold for the weld parameter or determining the weld parameter has deviated beyond a threshold for the weld parameter, as some examples. In some situations, the controller may determine two or more failure modes are occurring simultaneously during the welding process and may adjust the wire feed rate, heater electrical power, and/or laser power to address the failure modes.

The present disclosure also provides a hybrid machine tool comprising a spindle head configured to receive and rotate a tool for machining a workpiece having predetermined dimensions prior to machining thereof. The hybrid machine tool has a wire supply including a wire drive configured to advance a wire at a wire feed rate and a wire heater configured to apply resistive heating to heat the wire. The hybrid machine tool further includes an additive head for emitting a laser beam to weld the wire to a substrate and form the workpiece. A controller is operatively connected to the spindle head, wire supply, and the additive head. The controller is configured to adjust any of the wire feed rate, the resistive heating, and a power of the laser beam as the laser beam welds the wire to form the workpiece having the predetermined dimensions so that the workpiece can be precisely machined by operation of the spindle head. The controller is also configured to operate the spindle head to machine the workpiece having the predetermined dimensions via rotation of the tool. The ability of the controller to adjust any of the wire feed rate, the resistive heating, and the power of the laser beam enables the hybrid machine tool to provide a workpiece to be machined by the spindle head that has the desired dimensional and metallurgical properties needed to machine the workpiece into a part having predetermined final part properties with an accuracy of a few ten-thousandths of an inch. For example, by controlling the welding as the laser welds the wire to the substrate, the net geometry, tool life, and surface finish associated with machining the workpiece can be precisely controlled.

In another aspect of the present disclosure, a hybrid machine tool is provided that includes a spindle head, a wire supply to advance a wire toward a substrate, an optical head configured to emit a laser beam to weld the wire to the substrate, and a frame assembly configured for supporting the spindle head and the optical head for being driven along multiple transverse axes including an X axis. The frame assembly is configured for supporting the spindle head to be driven along a Y1 axis perpendicular to the X axis and along a Z1 axis perpendicular to the X axis and the Y1 axis. The frame assembly is configured for supporting the optical head to be driven along a Y2 axis parallel to the Y1 axis and perpendicular to the X axis independently of driving the spindle head along the Y1 axis. Further, the frame assembly is configured for supporting the optical head to be driven along a Z2 parallel to the Z1 axis and perpendicular to the X axis and the Y2 axis independently of driving the spindle head along the Z1 axis. The spindle head and the optical head have respective bodies with the spindle head body larger than the optical head body at least along the Y1 and Y2 axes and the Z1 and Z2 axes with the independent driving of the optical head relative to the spindle head along Y2 and Z2 axes allowing the optical head to be driven farther distances along the Y2 and Z2 axes than the spindle head is driven along the Y1 and Z1 axes, respectively. For example, the optical head may be independently driven along the Z2 axis 1.5 meters whereas the spindle head may be limited to a travel in the Z1 axis of a shorter, 800 cm distance due to size of the body of the spindle head.

The hybrid machine tool also includes a controller operatively connected to the spindle head, wire supply, optical head, and frame assembly and being operable to cause the optical head to be selectively driven along the multiple axes for producing a workpiece via the optical head welding the wire. Further, the controller is operable to rotate the spindle for machining the workpiece with the tool.

The present disclosure also provides a hybrid machine tool having a spindle head, a wire supply to advance a wire, and an additive head configured to emit a laser beam to weld the wire to a substrate. The hybrid machine tool further includes an air source, a shield gas source, a valve, and a controller. The valve has a first configuration wherein the valve directs air from the air source toward the additive head to protect the additive head from debris produced during machining of the workpiece and a second configuration wherein the valve directs shield gas from the shield gas source toward the additive head to provide a predetermined atmosphere for welding the wire. The controller is configured to shift the valve from the first configuration to the second configuration upon operation of the additive head. The shield gas provides an inert medium around the welding area to improve the welding process including limiting oxygen in the welding area, such as limiting the welding area to less than 2% free oxygen concentration. The controller shifts the valve from the second configuration to the first configuration upon a termination of the operation of the additive head. With the valve in the second configuration, the air provided to the additive head creates a higher air pressure area of the additive head than the surrounding environment which resists ingress of debris (such as millings) from operation of the spindle head into the additive head.

In another aspect of the present disclosure, a hybrid machine tool is provided that includes a spindle head, a temperature sensor to measure a temperature of a substrate, a wire supply to provide a wire, and an additive head configured to emit a first laser to weld the wire to a substrate. The substrate may be, for example, a base material secured to a table of the hybrid machine tool or a layer of previously-welded wire. The hybrid machine tool further includes a controller configured to determine whether the temperature of the substrate is at a target temperature based on the temperature of the substrate measured by the temperature sensor. Upon the temperature of the substrate not being at the target temperature, the controller adjusts the additive head to emit a second laser having a greater diffusion on the substrate than the first laser. The controller is further configured to cause the additive head to emit the second laser and heat the substrate to the target temperature. Because the hybrid machine tool may heat the substrate using a diffused laser from the additive head, the hybrid machine tool allows an operator to raise the temperature of the substrate to a temperature that may be desirable for welding by using the diffused laser rather than requiring the operator to heat the substrate in an oven and position the heated substrate in the hybrid machine tool.

The present disclosure also provides a method of heating a substrate using a hybrid machine tool having a spindle head and an additive head. The method includes measuring a temperature of a substrate and determining whether the substrate is at a target temperature. The method further includes adjusting the additive head to emit a diffused laser at the substrate upon the temperature of the substrate not being at the target temperature. The method further comprises causing the additive head to emit the diffused laser to heat the substrate. Further, the method includes causing the additive head to emit a welding laser that has a reduced diffusion on the substrate than the diffused laser to melt the substrate once the substrate has reached the target temperature. The method permits the hybrid machine tool itself to raise the temperature of the substrate to a temperature suitable for welding the wire to the substrate.

### BRIEF DESCRIPTION OF THE DRAWINGS

FIG. 1 is an elevational view of a hybrid machine tool having an additive head and a subtractive head for performing additive and subtractive processes;

FIG. 2 is a schematic representation of a portion of the hybrid machine tool of FIG. 1 showing a hot wire welding apparatus of the hybrid machine tool;

FIG. 3 is a perspective view of internal components of the hybrid machine tool of FIG. 1 showing a column including a spindle head and the additive head of the hybrid machine tool;

FIG. 4 is a view of the column of FIG. 3 with a housing of the column removed to show the additive head and a motor of the spindle head;

FIG. 5 is a perspective view of the additive head of FIG. 4 showing a wire feeder of the additive head;

FIG. 6 is an exploded view of the additive head of FIG. 5 showing the wire feeder, a tube, and a removable tray assembly including an optical head;

FIG. 7 is an exploded view of the removable tray assembly of FIG. 6 showing a conduit for directing wire from the wire feeder to a distal end portion of the additive head;

FIG. 8 is an enlarged view of the circled area in FIG. 7 showing a laser aperture tube, a shielding gas outlet, and a wire guide of the distal end portion of the additive head;

FIG. 9 is an elevational view of the optical head of FIG. 6 showing thermal sensors configured to detect the temperatures of various components of the optical head;

FIG. 10 is a top plan view of the hybrid machine tool of FIG. 1 showing a tool enclosure and an additive system enclosure;

FIG. 11 is a schematic view of an additive process control system of the hybrid machine tool of FIG. 1;

FIGS. 12 and 13 are a schematic view of a dynamic process control system of the additive process control system of FIG. 11;

FIG. 14 is a flow chart of a method of heating a workpiece using a diffused laser beam from the additive head of the hybrid machine tool of FIG. 1;

FIG. 15 is an elevational view of another hybrid machine tool having an additive head, a spindle head, and a table;

FIG. 16 is a perspective view of a portion of an interior of the hybrid machine tool of FIG. 15 showing the axes of movement of the additive head, the spindle head, and the table;

FIG. 17 is a perspective view of a frame assembly of the machine tool of FIG. 15 including a base, a saddle, and separate columns including the additive head and spindle head;

FIG. 18 is a perspective view of the saddle and columns of FIG. 17 showing the columns carried on the saddle;

FIG. 19 is an elevational view of the assembly of FIG. 18 showing the additive head and the spindle head each being independently movable along a respective Z axis via slide connections between the additive head, the spindle head, and their respective columns;

FIG. 20 is a cross-sectional view taken across line 20-20 in FIG. 19 showing an optical head of the additive head within a housing of the additive head; and

FIG. 21 is an elevational view of the optical head of FIG. 20.

### DETAILED DESCRIPTION

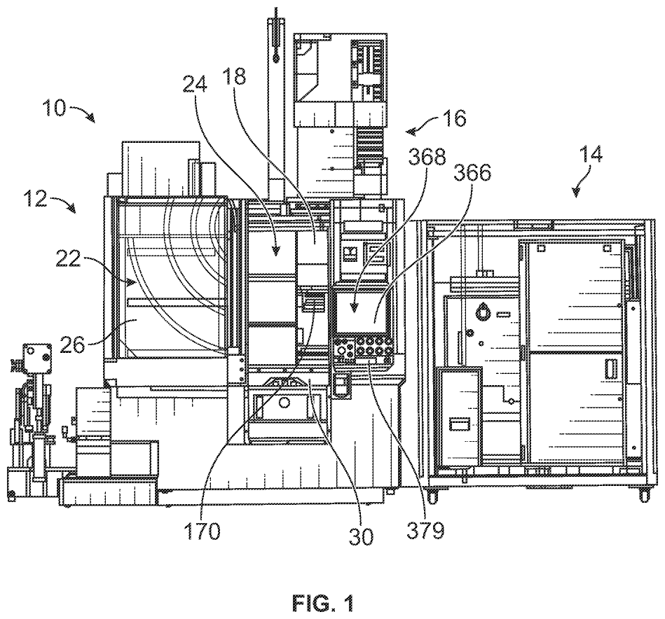

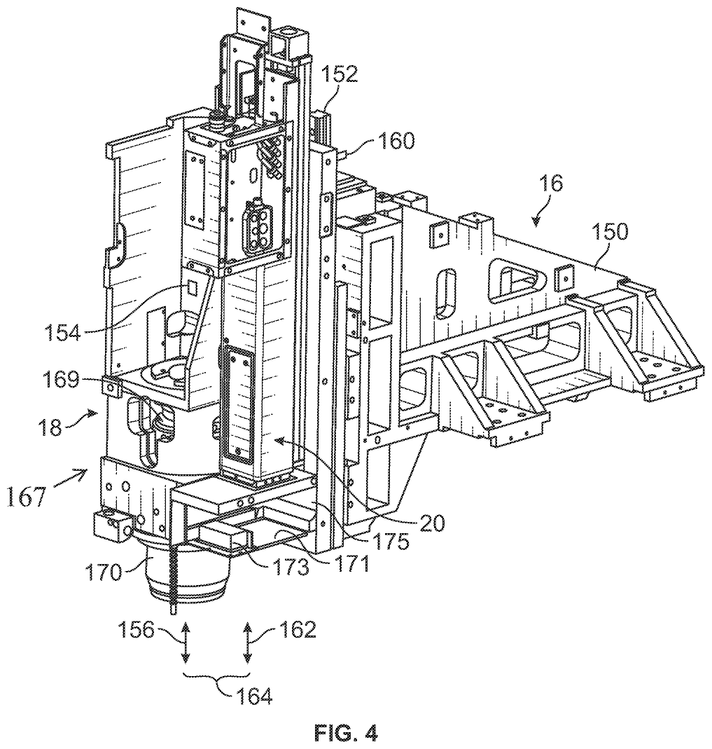

With respect to FIG. 1, a hybrid machine tool 10 is provided that includes a tool enclosure 12 and an additive system enclosure 14. The hybrid machine tool 10 has a vertical column 16 that includes a spindle head 18 and an additive head 20 (see FIG. 4). The hybrid machine tool 10 receives CNC programming, for example, via EIA/ISO programming such as MAZATROL® programming language, representative of a final part geometry. The additive head 20 utilizes hot wire welding to form a workpiece having an intermediate or additive net geometry by welding a heated wire to a substrate. The wire may include one or more metallic materials, such as ferrous and non-ferrous metals. Example metallic materials include steel, stainless steel, aluminum, titanium, invar, and/or inconel. The wire may be a composite material such as metallic material and a superhard material dispersed therein, such as tungsten carbide in particulate form. The additive head 20 progressively builds the part by welding the wire to an initial substrate, then progressively welding layers of the wire onto one another with each previous layer of the wire acting as a working substrate to which the current layer is welded. The CNC programming representative of the final part geometry may include slicing the final part geometry into layers that are progressively deposited by the additive head 20 to form the additive net geometry. The additive head 20 may utilize commercially available welding wire and is capable of depositing approximately 2.22 kg/hour with a material utilization rate of approximately 98%, which provides an economical and rapid approach for producing large parts.

The additive head 20 may be operated to produce a part having a somewhat coarse geometry. The hybrid machine tool 10 may then utilize one or more tools received in the spindle head 18 to machine the finished part from the workpiece with a high accuracy final geometry. The hybrid machine tool 10 is also operable to interleave additive and subtractive processes to produce parts having complex geometries while limiting the use of long tools. Long tools may need to be stronger to resist the loading applied during machining and as a result may be more expensive than a corresponding shorter tool. For example, the hybrid machine tool 10 may operate the additive head 20 to print a component having a hole. The additive head prints the component in 2 cm layers. After printing each 2 cm layer, the hybrid machine tool 10 then operates the spindle head 18 so that a tool received therein machines a portion of the hole portion in the 2 cm layer. The portion of the hole in each layer is aligned with the portion of the hole in the previous layer. The hybrid machine tool 10 may thereby progressively form a part having a deep precision hole while using a 2 cm cutter. Other benefits of the interleaving process may include decreased cycle time, better geometric control of internal features, and eliminated necessity of custom tooling or fixtures.

Referring to FIG. 1, the tool enclosure 12 includes a housing 22 that encloses a work room 24 and a door 26 that is movable between open and closed positions to facilitate access to the work room 24. The hybrid machine tool 10 has a table 30 for supporting a part during both the additive and subtractive processes. A fixture is used to secure the part to the table 30.

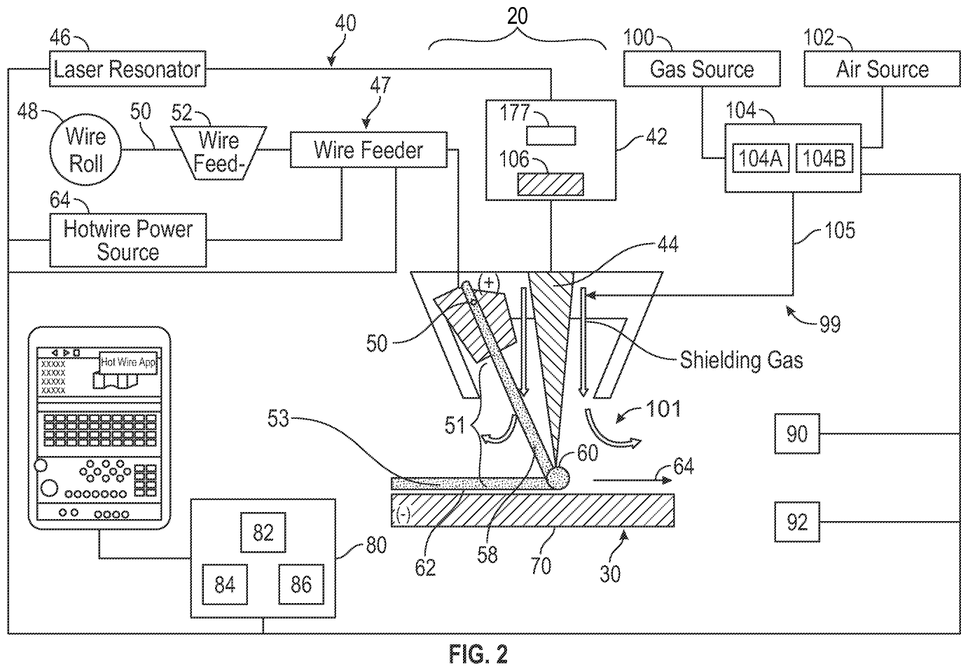

Referring to FIG. 2, the hybrid machine tool 10 has a hot wire welding apparatus 40 that includes the additive head 20. The hot wire welding apparatus 40 includes an optical head 42 of the additive head 20 that emits a laser beam 44. In one embodiment, the optical head 42 is a component of a fiber laser. A fiber laser utilizes laser light created by diodes that is channeled and amplified in fiber optic cable which may be doped in rare-earth elements. The amplified light is collimated and focused by one or more lenses onto the target material. An example of a suitable optical head is a 200 MMFL Fibermini 2.0 sold by Laser Mechanisms, Inc. The optical head 42 may be capable of being used as a cutting laser, if so configured. The optical head 42 is the torch of the hybrid machine tool 10, with the optical head 42 providing final collimation, focus, and emission of the laser beam.

Regarding FIG. 2, the hot wire welding apparatus 40 further includes a laser resonator 46 to generate the laser and a wire supply 47 to provide wire to the additive head 20. In one embodiment, the wire supply 47 includes a wire spool or roll 48 for supplying wire 50, a wire feeder 52, and a wire feeder 54 of the additive head 20. The wire feeder 52 pays out the wire 50 from the wire roll 48, such as by pushing the wire 50 off of the wire roll 48, and then the wire feeder 54 pulls the wire 50 down through conduit 212 into a guide 56 connected to the optical head 42. The guide 56 orients and directs the wire 50 such that an end portion 58 of the wire 50 is advanced into a puddle or melt pool 60 in a bead 62. As shown in FIG. 2, the laser beam 44 is directed toward a base material or substrate 70 and forms the melt pool 60 by melting the substrate 70. The wire 50 is advanced into the melt pool 60 wherein the wire 50 melts and mixes with the substrate 70. As the optical head 42 is moved in direction 64, the wire 50 is welded to a substrate 70 which forms the bead 62. The bead 62 cools and hardens as the optical head 42 moves in direction 64.

Continuing reference to FIG. 2, the hot wire welding apparatus 40 includes a wire heating power source 64 that provides power to the wire feeder 54 so that the wire feeder 54 also heats the wire 50. The wire 50 is a metallic material, such as steel alloys, bronze, aluminum, titanium, stainless steel, duplex steel, and nickel-based alloys. The wire 50 utilized for a particular part may have a diameter selected for the part, such as approximately 0.035 inch, 0.045 inch, or 0.063 inch diameter. As an example, a deposition utilizing approximately 0.045 inch wire produces a deposition height of approximately 1.2 mm for each layer. The wire heating power source 64 and wire feeder 52 heat the wire 50 using electrical resistive heating to a plastic state, wherein the wire has a more pliable consistency as the wire 50 is advanced toward the melt pool 60. More specifically, the wire heating source 64 and/or the wire feeder 54 apply a current and a voltage to the wire 50, and the resistance to the flow of electricity through the wire 50 generates heat which heats the wire. The table 30 is operatively connected as a process return lead for the wire heating source 64 such that electricity travels through the wire 50 to the table 30. The electricity flowing through the wire 30 to the table 30 and back to the wire heating source 64 is isolated from the rest of the electrical systems of the hybrid machine tool 10. The wire 50 is heated so that the wire 50 approaches the melting temperature of the wire 50 to readily conform to and adhere to the substrate during the additive process. The hot wire welding apparatus 40 provides a preheat zone 51 wherein the wire 50 is raised to a temperature suitable for welding and a deposited zone 53 wherein the wire 50 has been welded to the substrate 70. In one approach, the wire 50 has a consistency resembling toothpaste when the wire 50 is in the preheat zone 51 and is advanced into the melt pool 60. The wire in the preheat zone 51 is heated by the resistive heating as well as the heat from the welding process. The wire 50 may be relatively solid upstream of the preheat zone 51 so that the wire 50 may be advanced by the wire feeder 54 in the additive head 20 toward the laser beam 44.

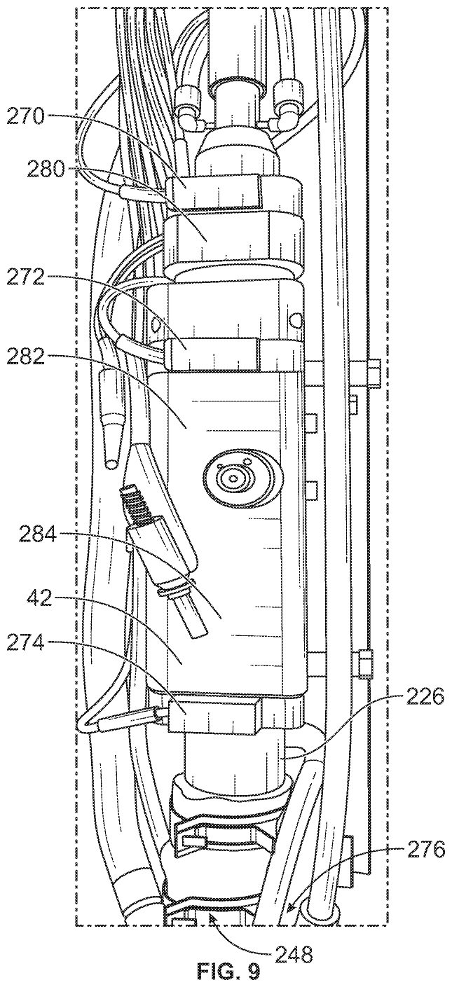

The hybrid machine tool 10 includes a controller 80 having a processor 82, a memory 84, and communication circuitry 86. The memory 84 is a non-transitory computer readable medium and stores instructions that, when executed by the processor, cause the processor 82 to perform operations as discussed herein. The communication circuitry 86 facilitates interfacing of the processor 82 with various components such as a sensor. For example, the hybrid machine tool 10 may include one or more optical sensors, such as a camera 90, one or more sound sensors, such as a microphone 92, and one or more thermometers such as thermometers 270, 272, 274, 276 (see FIG. 9) as discussed below. In one example, the processor 82 includes one or more microprocessors, the memory 84 include volatile and/or non-volatile memory (e.g., electro-mechanical data storage, EEPROM, RAM, NAND flash memory), and the communication circuitry 86 includes a Wi-Fi® network interface, a Bluetooth® interface, and/or a wired ethernet connection.

In one embodiment, the camera 90 is a thermal imaging camera. The processor 82 utilizes data from the camera 90 to determine a temperature and/or a size of the melt pool 60, temperature of the bead 62, and/or the temperature of the end portion 58 of the wire 50, as some examples. The processor 82 may operate the camera 90 to detect arcing as well as the color of the light emitted by the hot wire welding process.

The microphone 92 may detect sounds associated with the hot wire welding process that are indictive of the properties of the process. For example, the processor 82 may utilize data from the microphone 92 to detect crackling, inconsistencies, or sharp changes in the sound emitted by the hot wire welding process. As discussed in greater detail below, the processor 82 may utilize data from the camera 90 and microphone 92 to identify issues with the hot wire welding process and adjust parameters of the process as needed.

The hybrid machine tool 10 is configured to be connected to an inert gas source 100 for providing a shield or inert gas, such as argon, to a welding area 101 (see FIG. 2) at the weld site. The hybrid machine tool 10 provides an oxygen content in the welding area encompassed by the shield gas that is below 1% free oxygen concentration. The hybrid machine tool 10 is also configured to be connected to an air source 102 for providing clean, dry air. The hybrid machine tool 10 has a cover lens assist gas circuit 99 including a valve, such as one or more solenoids 104, configured to place the inert gas source 100 or the air source 102 in communication with the optical head 42. In one embodiment, the solenoid 104 includes an air solenoid 104A and a gas source solenoid 104B. The operation of the solenoid 104 may be controlled by the processor 82 such that when the additive head 20 is active, the solenoid 104 permits the inert gas source 100 to direct the argon gas to the optical head 42 and the welding area 101. When the hot wire welding process has stopped, the processor 82 operates the solenoid 104 to direct air from the air source 102, such as a compressed air shop line, to the optical head 42. The air source 102 may be configured to create a positive air pressure proximate to a cover lens 106 of the optical head 42. The positive air pressure near the cover lens 106 keeps dust, metal shavings, and other debris away from the cover lens 106 which prolongs the life of the cover lens 106. In one embodiment, the cover lens assist gas circuit 99 directs the clean, dry air into a compartment 177 above the cover lens 106. The air provided into the compartment 177 creates a high pressure area that resists ingress of debris into a compartment 175 (see FIG. 4) of the additive head 20. The cover lens 106 may be relatively close to the machining operation due to the proximity of the optical head 42 to the spindle head 18, such that the positive air pressure near the cover lens 106 protects the cover lens 106 and may reduce the frequency of needing to replace the cover lens 106.

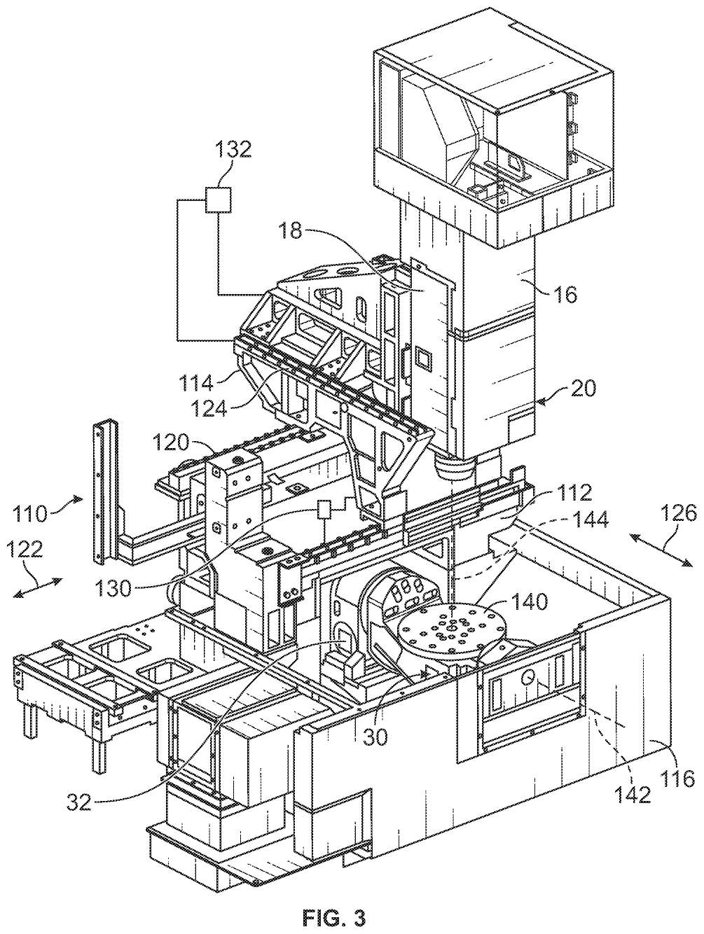

Referring to FIG. 3, the hybrid machine tool 10 has a frame assembly 110 including a base frame 112, an intermediate frame such as a saddle 114, and head frame such as the column 16. The hybrid machine tool 10 has a large base 116 supporting the housing 28 and the base frame 112. The saddle 114 and base frame 112 have one or more slide connections therebetween, such as linear guides 120, that permit movement of the saddle 114 along a horizontal X-axis 122. The column 16 and saddle 114 have one or more slide connections therebetween, such as linear guides 124 that permit movement of the column 16, and the spindle head 18 and additive head 20 thereof, along a horizontal Y-axis 126. The hybrid machine tool 10 includes a saddle drive 130 in communication with the processor 128 and operable to drive the saddle 114 along the X-axis 122. The hybrid machine tool 10 further includes a column drive 132 configured to drive the column 132 along the Y-axis 126. The saddle drive 130 and column drive 132 may each include one or more motors and transmission components to effect movement of the saddle 114 and the column 16.

Referring to FIG. 3, the table 30 includes a table drive 32 and a table top 140. The table top 140 includes an upper surface for supporting an initial substrate and one or more mounting portions, such as openings in the table top 140, for mounting the initial substrate to the table top. The table drive 32 includes one or more motors to effectuate movement of the table top 140. The table drive 32 is operable to drive the table top 140 in rotary directions about a B-axis 142 and a C-axis 144 perpendicular to the B-axis.

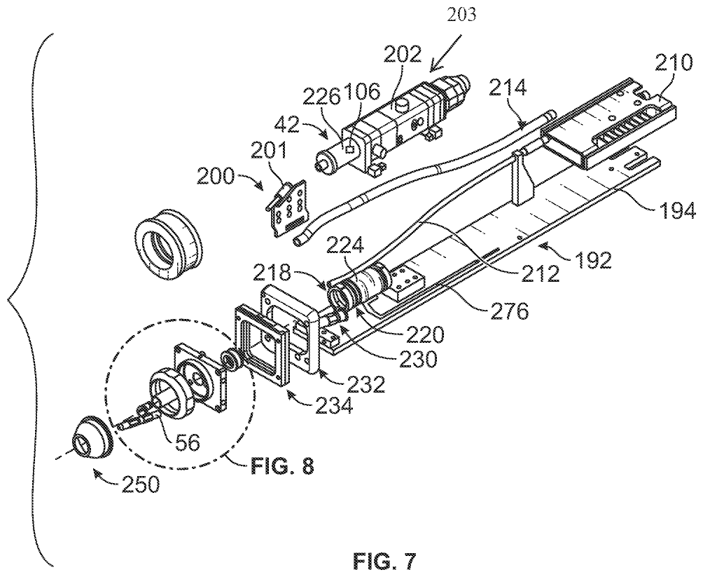

Referring to FIG. 4, the column 16 includes a column frame 150. The spindle head 18 and additive head 20 are slidably connected to the column frame 150 such as by linear guides 152 so that each of the heads 18, 20 are independently slidable relative to each other. The column 16 includes a spindle head drive 154 operable to shift the spindle head 18 along a vertical Z1-axis 156 and an additive head drive 160 operable to shift the additive head 20 along a vertical Z2-axis 162. The vertical Z1 and Z2 axes 156, 162 are orthogonal to the horizontal X and Y axes 122 and 126. The spindle head 18 has a body 167 that is larger than a body 203 (see FIG. 7) of the optical head 42 along the Y1, Y2 axes and the Z1, Z2 axes. The spindle head 18 including a motor 169 operable to rotate a spindle 170 of the spindle head 18 about the Z1-axis 156. The large body 167 of the spindle 18 provides rigidity and inertia to provide precise machining using the spindle head 18. In one embodiment, the spindle 170 includes a collet for receiving a tool. The additive head 20 directs the laser 44 along the Z2-axis 162. The spindle head 18 and additive head 20 are positioned side-by-side on the column frame 150. There is a lateral offset 164 between the Z1-axis 156 of the spindle head 156 and the Z2-axis 162 of the additive head 20.

In one embodiment, the drives 130, 132, 154, 160 of the frame assembly 110 include ball screws with servomotors and encoders. The drives permit accurate relative shifting of the components of the frame assembly along respective axes.

The additive head 10 includes a cover 171 and an actuator 173 operably coupled to the controller 80. The actuator 173 is configured to remove the cover 171 from a closed position when the additive head 20 is inactive to an open position when the additive head 20 is active. The cover 171 helps protects the components of the additive head 20, such as cover lens 106, from dust, metal millings, and other debris.

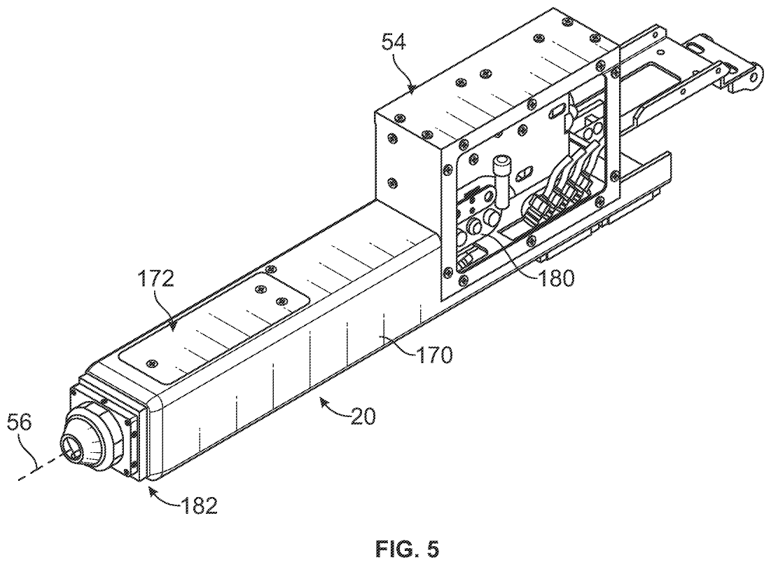

With reference to FIG. 5, the additive head 20 includes a housing 170, an optical assembly 172 including the optical head 42, and a wire feeder 54. The wire feeder 54 includes one or more roller assemblies 180 that are controlled by the processor 82 to advance the wire 50 to the guide 56 for the wire 50 at a distal end portion 182 of the additive head 20.

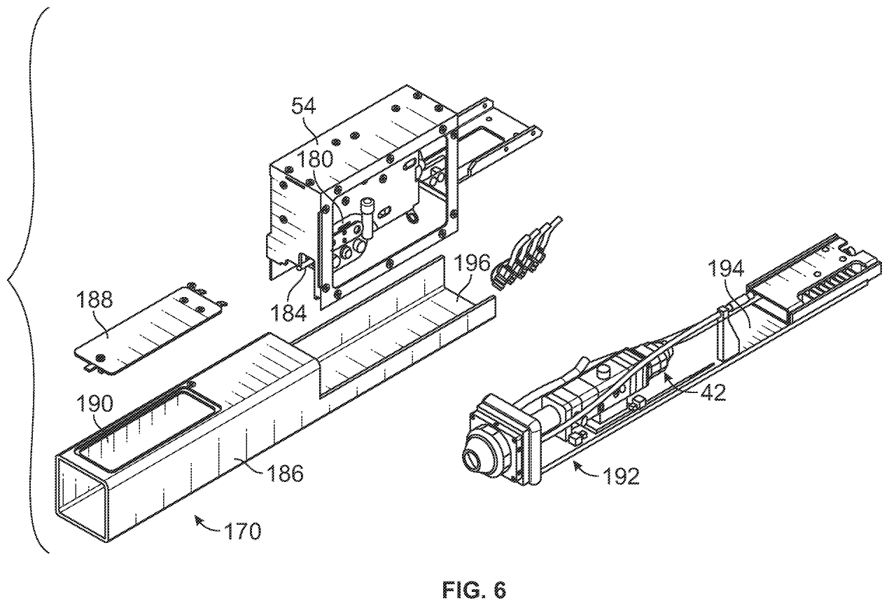

Referring to FIG. 6, the wire feeder 54 includes the drive roller assemblies 180 and a wire feed guide tube 184. The housing 170 has a forward tubular portion 186 having a polygonal, e.g. square, cross-sectional configuration with one of the sides thereof including an access door 188 for closing an opening 190 in the forward tubular portion 186 and permitting access to the optical assembly 172. The additive head 20 further includes a removable tray assembly 192 having a tray 194 for supporting the optical head 42. The removable tray assembly 192 is slidably received in a rear channel 196 of the forward tubular portion 186 for being slid forward therealong so that the optical head 42 is disposed in the forward tubular portion 186.

Referring to FIG. 7, the additive head 20 includes a lock 200 having a solenoid 201 operably coupled to the controller 80. The lock 200 has a locked configuration that inhibits separation of the components 202 of the optical head 42 that must be separated to access the cover lens 106 of the optical head 42. Upon an instruction from a user, the controller 80 may cause the solenoid 201 of the lock 200 to shift to an unlocked configuration which permits separation of the components 202 when the hybrid machine tool 10 is inactive and the air source 102 is turned off. In this manner, the lock 200 keeps the user from replacing the cover lens 106 while the air source 102 is turned on which, in turn, inhibits the air source 102 from blowing debris in the workroom 24 into contact with the optical head 42.

Continuing reference to FIG. 7, the removable tray assembly 192 includes a distribution terminal block 210, a wire conduit 212, a shield gas conduit 214, thermometer 276, a band clamp 218, and a sleeve 220 for securing a shroud 224 to an outlet tube 226 of the optical head 42. The wire conduit 212 for the wire 50 connects to the guide 56 by way of a fitting 230. The removable tray assembly 192 further includes an insulating plate 232 and a slide plate 234. The insulating plate 232 isolates the hot wire welding system electrically from the rest of the machine. Slide plate 234 is a crosslide assembly, used to position the wire feed location by adjusting the position of the guide 56. The slide plate 234 is manually adjustable to set the wire feed location during machine setup or for troubleshooting, as some examples.

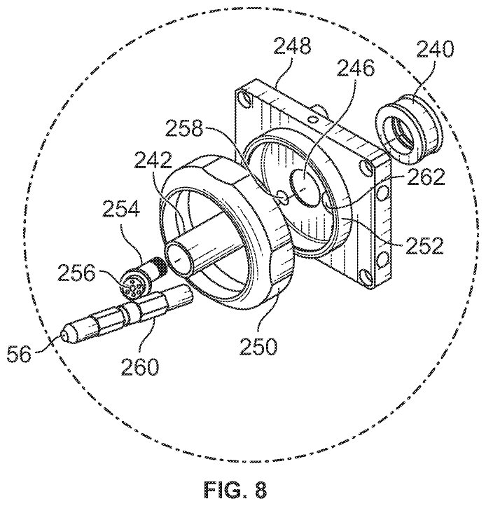

Referring to FIG. 8, the distal end portion 182 of the additive head 42 includes an adapter 240 having an annular configuration to connect the outlet tube 226 of the optical head 42 to an aperture tube 242. The aperture tube 242 fits through a central opening 246 of a laser nozzle cooling block 248. The distal end portion 182 of the additive head 20 further includes an annular nozzle retainer 250 configured to be threadingly engaged with an annular flange 252 of the contact block 248. The distal end portion 182 further includes the guide 56 that connects to the conduit fitting 230 and a shield gas fitting such as an elbow 254. The elbow 254 receives shield gas via the shield gas conduit 214 and includes an outlet for shield gas, such as a diffuser 256 having a plurality of openings therein. The elbow 254 fits in an opening 258 of the contact block 248 and is connected thereto. The guide 56 has a fitting portion 260 with a plurality of flats, the fitting portion 260 sized to fit through an opening 262 of the contact block 248.

Referring to FIG. 9, the additive head 20 includes a plurality of thermal sensors, such as a thermometer 270, a thermometer 272, a thermometer 274, and the thermometer 276. The thermometers 270, 272, 274, 276 each include one or more thermistors, as one example. The thermometer 270 detects a temperature of a laser collimator 280 of the optical head 42 and the thermometer 272 detects a temperature of a laser optics body 282 of the optical head 42. The thermometer 274 detects a temperature of the cover lens 106 and the thermometer 276 detects a temperature of the laser nozzle cooling block 248. The optics body 282 includes an adjustable lens holder spacer 284 to facilitate the desired focusing of the laser.

The controller 80 is operably coupled to the thermometers 270, 272, 274, 276 and may take remedial measures in response to one or more temperatures detected at the thermometers 270, 272, 274, 276 exceeding a respective threshold. The controller 80 may have different threshold temperatures set for the different thermometers 270, 272, 274, 276. The different threshold temperatures may be due to the upward dissipation of heat from lower components of the optical head 42 to higher components of the optical head. Further, the temperature thresholds may be set accordingly to the sensitivity of the components of the optical head 42. For example, the threshold temperature at thermometer 276 may be 32° C., the threshold temperature at thermometer 274 may be 33° C., the threshold temperature at thermometer 272 may be 35° C., and the threshold temperature at thermometer 270 may be 40° C. As a further example, the threshold temperatures of the thermometers 276, 274, and 272 may all be in the range of approximately 32° C. to approximately 35° C.

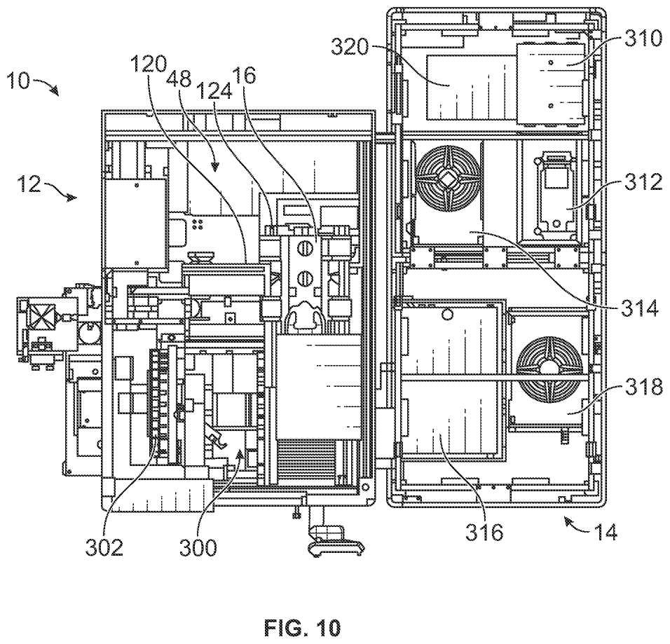

Referring to FIG. 10, the hybrid machine tool 10 includes an automated tool changer 300 and a magazine 302 which releasably holds different cutting tools. The automated tool changer 300 may load and unload tools from the magazine 302 into the spindle 170. As shown in FIGS. 2 and 10, the hot wire welding apparatus 40 includes an additive manufacturing transformer 310 for providing electrical power to the components of the hot wire welding apparatus 40. The hot wire welding apparatus 40 further includes a wire heating source controller 312, an additive head chilling unit 314, a laser resonator 316 to generate laser light, and a laser resonator chilling unit 318 for cooling the laser resonator 316. The laser resonator 316 is operatively connected to the optical head 42 such that the laser light generated by the laser resonator 316 is routed to the optical head 42, and the optical head 42 focuses the laser light into a beam that is emitted via an aperture tube 242 (see FIG. 8). The additive system enclosure 14 may also include a main spindle chiller 320 to dissipate heat from the operation of the spindle 170.

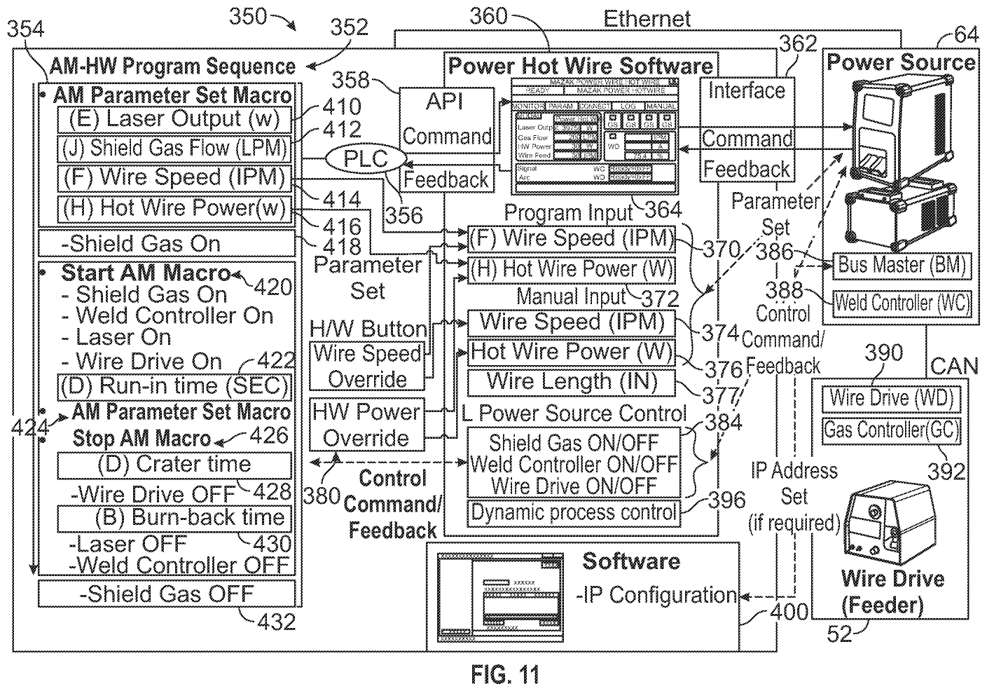

Referring to FIG. 11, the hybrid machine tool 10 has an additive process control system 350 that operates various components of the hybrid machine tool 10 to facilitate the additive manufacturing process. The additive process control system 350 utilizes an additive manufacturing hot wire program sequence 352 which operates an additive manufacturing parameter set macro 354. The additive manufacturing hot wire program sequence 352 communicates via a programmable logic controller 356 and an application process interface 358 with power hot wire software 360. The power hot wire software communicates via an interface 362 with the wire heating power source 64 and the wire feeder 52. The wire feeder 52 may have a master-slave arrangement with the wire feeder 54 such that the wire feeders 52, 54 coordinate to advance the wire 50.

The power hot wire software 360 may generate a graphical unit user interface 364 to be provided at a display, such as a screen 366 (see FIG. 1) of a user interface 368 of the hybrid machine tool 10. The power hot wire software 360 may receive the wire speed 370 and hot wire power 372 parameters from the additive manufacturing parameter set macro 354. The hot wire power 372 parameter may be, for example, a value or level of power (watts), current (amps), and/or voltage to be applied to the wire.

The power hot wire software 360 may also receive wire speed 374 and hot wire power 376 parameters input via a keyboard 369 of the user interface 368. The user interface 368 may also include wire speed and hot wire power overrides 380 to override the current wire speed and a hot wire power. The power hot wire software 360 also estimates a length 377 of the wire consumed during an additive process based at least in part on the feed rate and the time elapsed.

The power hot wire software 360 includes a power source control section 384 that functions to control supply of a shield gas (e.g., by controlling the solenoid 104), operation of the wire heating source 64, and operation of the wire feeder 52. The wire heating power source 64 includes a bus master 386 and a weld controller 388 whereas the wire feeder 52 includes a wire drive 390 and a gas controller 392. The gas controller 392 turns on and off the shield gas provided to the gas circuit 99.

The power hot wire software 360 may receive parameters from the additive manufacturing hot wire program sequence 352 as well as provide control feedback via the API 358. In some applications, the power hot wire software 360 may also include a dynamic process control system 396 which operate in conjunction with the additive manufacturing hot wire program sequence 352. The dynamic process control system 396 may provide a closed-loop control system for controlling the machine. The additive process control system 350 may include software 400 to facilitate communication between the wire heating power source 64, the wire feeder 52, and the controller 80 of the hybrid machine tool 10. The communication facilitated by the software 400 permits the controller 80 to coordinate operation of the wire heating power source 64 and wire feeder 52 with operation of the additive head 20.

Continuing reference to FIG. 11, the additive manufacturing hot wire program sequence 352 may be configured so that a user enters operating parameters into an additive manufacturing parameters set macro 354 including a laser output parameter 410, a shield gas flow parameter 412, a wire speed parameter 414, and a hot wire power parameter 416. Alternatively or additionally, the additive manufacturing hot wire program sequence 352 may be configured so that the processor 82 retrieves parameters such as by the processor 82 retrieving the parameters from a local or remote server via the communication circuitry 86 and an intranet and/or the internet.

The additive manufacturing hot wire program sequence 352 next includes the power source control 384 setting 418 the shield gas to an “on” state and starting an additive manufacturing macro 420. The additive manufacturing macro includes turning on the weld controller 388, the optical head 42, and the wire drive 390. The additive manufacturing macro 420 further includes receiving a running time parameter 422. The running time parameter 422 represents a dwell time wherein the wire feed is passed to allow the wire to reach the substrate.

The additive manufacturing hot wire program sequence 352 next includes the additive manufacturing parameter set macro operation 424 and then stopping 426 the additive manufacturing macro 420. The additive manufacturing parameter set macro operation 424 takes the programmed additive manufacturing parameters from macro variable data registers and shares them with the power hot wire software 360 for implementation.

The stopping 426 may include an identification of a crater time parameter 428 as well as a burn back time parameter 430. The crater time parameter 428 represents a time period to stop wire feed and build out a crater in the melt pool 60. The burn back time parameter 430 represents a time period to stop wire feed and use the laser to burn back the wire from the substrate and limit adhesion. The stopping 426 may also include turning off the wire drive 390, the weld controller 388, and the optical head 42. Finally, the additive manufacturing hot wire program sequence 352 includes turning 432 the shield gas off.

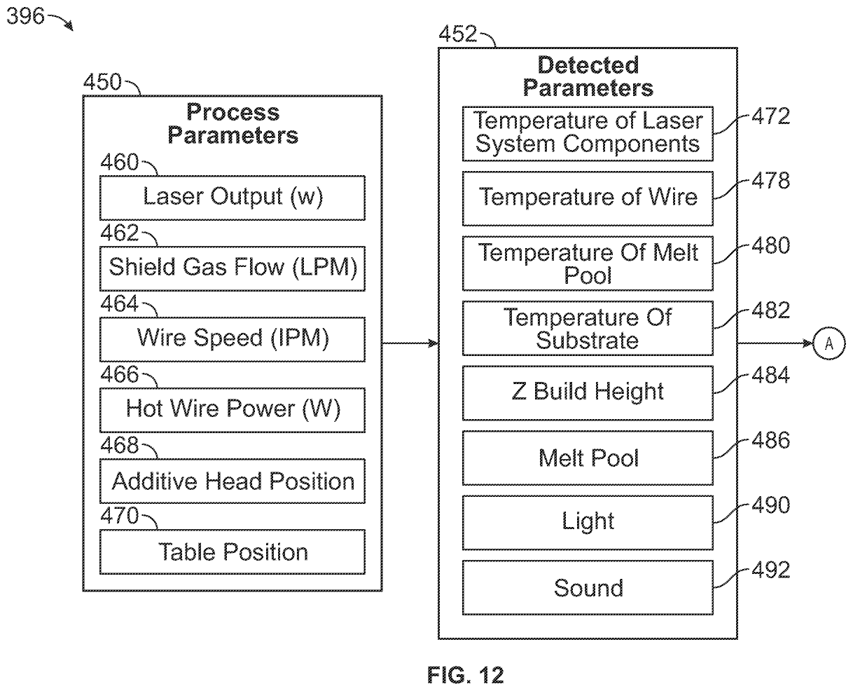

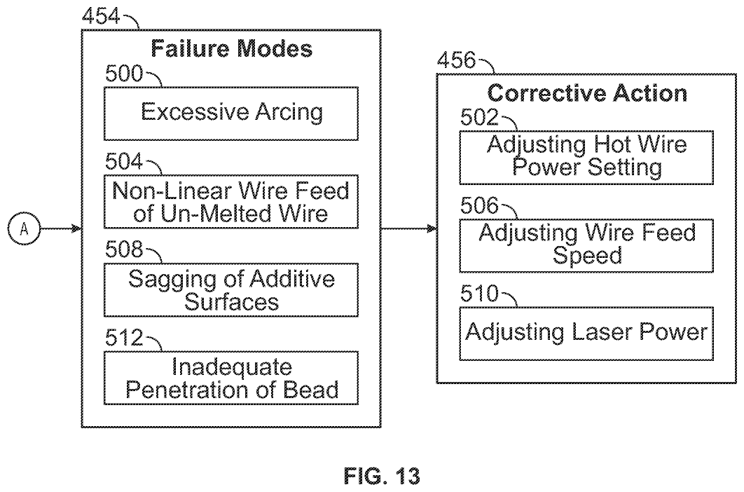

Referring to FIGS. 12 and 13, the dynamic process control system 396 may utilize process parameters 450 and detected parameters 452 to identify failure modes 454 and automatically adjust operation of the hybrid machine tool 10 via one or more corrective actions 456. The dynamic process control system 396 may repeatedly check the process parameters 450 during a welding process to determine whether one of the failure modes 454 is occurring. For example, the dynamic process control system 396 may check the process parameters 450 at set or varying time periods, e.g. every 10 seconds, or at intervals associated with predetermined movements of the additive head, such as changing a direction of travel or starting/ending a new layer of material. The dynamic process control system 396 may determine the failure mode 454 upon a process parameter 450 approaching a threshold, crossing a threshold, being a percentage of a predetermined value, etc. The determining of the failure mode 454 may involve determining the failure mode 454 before the failure mode actually occurs, such as predicting a failure mode based on a trend in one or more of the process parameters 450. The one or more corrective actions re-establish a stable welding process as discussed below. The dynamic process control system 396 may adjust the process parameters 450 from the start of the welding process to the end at various times through the process and without turning off the laser beam.

The process parameters 450 may be received from the additive manufacturing hot wire program sequence 352 and/or received from the user interface 368. The process parameters 454 may include laser output 460, shield gas flow 462, wire speed 464, hot wire power 466, additive head position 468, and/or table position 470. The additive head position 468 may include an absolute position, speed, velocity, acceleration, direction, and/or a position of the additive head 20 relative to another component as some examples. The table position 470 may include absolute position, speed, direction, velocity, acceleration, direction, and/or a position of the table top 140 as some examples. The process parameters 450 are provided to the dynamic process control system 396 initially and then the dynamic process control system 396 undertakes a feedback loop which may automatically adjust the process parameters 450 as part of implementing the corrective action 456.

The detected parameters 452 are detected by one or more sensors of the hybrid machine tool 10. The detected parameters 452 may include, for example, the temperature 472 of the laser system components (such as the temperatures detected by thermometers 270, 272, 274, 276), the temperature 478 of the wire 50, the temperature 480 of the melt pool 60, and the temperature 482 of the substrate. The substrate may be, for example, an initial substrate that the first layer of the bead 62 is formed on, such as block or plate, or a working substrate in the form of a previously deposited bead 62 that the wire 50 is currently being welded to. In one example, the substrate for the first bead is a block to which the wire is welded, the substrate for the second bead is the first bead to which the wire is welded, the substrate for the third bead is the second bead to which the wire is welded, etc.

The detected parameters 452 also include the Z vertical build height 484, and a melt pool appearance parameter 486 such as the size and/or shape of the melt pool. The detected parameters 452 may further include one or more light parameters 490 during deposition, such as the color of the light generated, the intensity of the light generated, interruptions in the light generated, and/or arcing. The change of color may include a change in hue or shade of color. The detected parameters 452 may further include one or more sound parameters 492 relating to the sound detected during deposition. The sound parameters 492 may include a sound amplitude, a sound frequency, and/or different types of sounds, such as crackling, which may indicate deviations from a satisfactory weld.

A stable hot wire welding process may have characteristics relating to the appearance and sound of the welding process that indicate the welding process is stable and will provide a satisfactory weld. In one approach, a stable hot wire welding process may be identified as a process having a consistent orange or yellow glow to the light produced during the welding process. There may be zero or a minor number, such as one or two per minute, of flashes or intense blue light arcs during deposition in any direction of movement of the additive head 20. The stable hot wire welding process may also be relatively quiet. There may be no noticeable buzzing, crackling, and/oscillating noise during the deposition. A stable hot wire welding process results in a bead having a clean, bright, and consistent visual appearance. The bead from the weld should have a smooth, bright finish and be of a consistent width and height. The bead should have little or no contamination such as soot or spatter.

Continuing reference to FIG. 13, the dynamic process control system 396 may utilize the one or more sensors, such as the camera 90 and/or the microphone 92, to monitor the hot wire welding process to determine that excessive arcing 500 is occurring. Excessive arcing may be detected by bright blue light flashes upon direction changes of the additive head 20, bright blue light flashes constantly oscillating along the bead, or bright blue light flashes at random intervals along the bead. The excessive arcing can result in a discontinuous bead, discoloration of the substrate, pitting of the substrate, and/or excessive soot or spatter on the workpiece. The excessive arcing 500 may be caused by excessive hot wire power 466 resulting in an arc flash between a discontinuous wire feed and the substrate. The dynamic process control system 396 may take a corrective action 456 that includes adjusting 502 the hot wire power setting. For example, the adjusting 502 may include adjusting the hot wire power 466 down in 1% increments until a stable process is detected. The adjusting 502 may include, for example, adjusting a current, voltage, or a combination of current and voltage to change the electrical power applied to the wire.

The dynamic process control system 396 may determine that non-linear wire feed of the un-melted wire 504 is occurring, such as by visually detecting twisting, bending, or other non-linear movement of the wire 50 via the camera 90. Non-linear wire feed is typically caused by the wire not being adequately pre-heated to a plastic state before the wire contacts with the substrate. Due to the wire still being firm, the wire abuts against the substrate and deflects in various directions until the laser energy melts the wire to a liquid state. The remaining, un-melted wire springs back straight and abuts the substrate which restarts the non-linear feed cycle.

The non-linear wire feed wire produces excess stringers attached to finished components. Consistent, noticeable non-linear feed of the wire around the melt pool 60 causes the wire to be out of position and become welded to the bead 62. Less extreme cases of non-linear wire feed can result in pitting around the bead toes and discontinuous beads 62. The term bead toes refers to the lateral side portions of the bead where the bead interfaces with the substrate, such as the laterally outermost 7.5%-10% of a cross section of the bead taken perpendicular to the longitudinal length of the bead. The non-linear wire feed of the un-melted wire 504 may be caused by physical resistance to advancing of the wire 50 due to contact between improperly heated wire 50 and the substrate. The corrective action 556 may include adjusting 506 the wire speed down in 1% increments until the process stabilizes and non-linear wire feed does not occur.

As an additional or alternative cause, the non-linear wire feed of the unmelted wire 504 may be caused by inadequate hot wire power 466 causing an improperly melted wire feed to collide with the substrate. The corrective action 556 may include adjusting 506 the hot wire power 466 up in 1% increments until the process stabilizes and non-linear wire feed does not occur.

The failure modes 454 may include sagging of additive surfaces 508, which may be identified by the camera 90. The slumping or sagging of the additive surfaces results in an excessive liquification and a weld bead 62 that has a lower height and/or is wider than is desired. In one embodiment, the controller 80 includes a personal computer connected to the hybrid machine tool 10 via an ethernet connection. The personal computer has software that utilizes data from the camera 90 and the processor 82 to compare actual workpiece geometry to projected workpiece geometry. The software of the personal computer determines any deviations, e.g., inadequate bead height, from the projected workpiece geometry and provides a trigger to the processor 82 of the hybrid machine tool 10 to address the sagging of additive surfaces 508.

In another approach, the processor 82 may determine the height and/or width of the weld bead 62 using an image of the weld bead 62 taken by the camera 90, such as a frame of a video, and compare the determined height and/or width of the weld bead 62 to a target height and/or width.

Further, the slumping or sagging of additive surfaces includes the substrate having an inability to shed heat fast enough and produces a cherry red glow which may be detected via the camera 90 using thermal imaging. The sagging of additive surfaces 508 may result in a pool of melted metal and sagging of bead geometry near the center of the bead 62. The slumping of additive surfaces 508 may be caused due to excessive laser power. The corrective action 456 may include adjusting 510 the laser output 460 down in 1% increments until the process stabilizes and sagging of the additive surfaces does not occur.

The failure modes 454 may also include an inadequate penetration of the bead 512. In this failure mode, the bead 62 (see FIG. 2) has significant toeing in and excessive bead height relative to the bead width. In one embodiment, the controller 80 includes a personal computer connected to the hybrid machine tool 10 via an ethernet connection. The personal computer has software that utilizes data from the camera 90 and the processor 82 to compare actual workpiece geometry to projected workpiece geometry. The software of the personal computer determines any deviations from the projected workpiece geometry, e.g., excessive bead height, and provides a trigger to the processor 82 of the hybrid machine tool 10 to address the inadequate penetration of the bead 512.

In another approach the processor 82 may determine the toeing in and excessive bead height using an image of the weld bead 62 taken by the camera 90 by using an image recognition algorithm that compares the toeing in and bead height of the bead 62 to target values.

Inadequate penetration of the bead 512 results in poor bonding between the bead 62 and the substrate as well as a discontinuous bead. The inadequate penetration of the bead 512 may be due to inadequate laser power causing lack of penetration of heat into the substrate and an inability to maintain a continuous melt pool 60. The corrective action 456 may include adjusting 510 the laser output 460 by increasing the laser power in 1% increments until the process stabilizes and inadequate penetration of the bead 512 is not occurring.

In some embodiments, the power hot wire software 360 may be configured to allow a user to manually adjust one or more of the parameters 460, 462, 464, 466, 468, 470 during a hot wire welding operation. In this manner, a manual control of the hot wire welding process is available to the user.

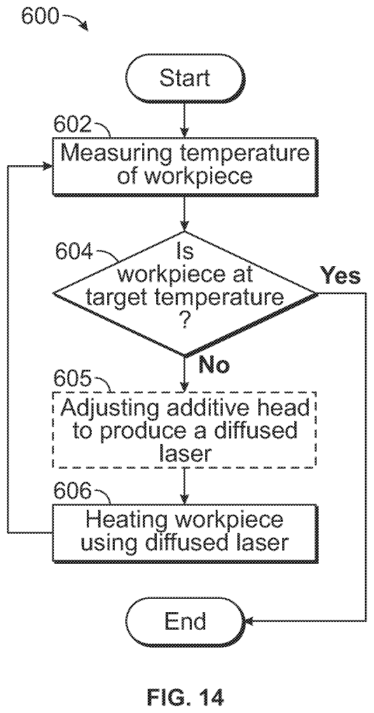

Regarding FIG. 14, a method 600 is provided of utilizing energy from a diffused laser to heat a workpiece. The method 600 includes measuring 602 a temperature of a workpiece. The temperature measuring 602 may include, for example, measuring the temperature of a substrate that has been secured to the table 30 via the camera 90, an infrared thermometer, and/or a thermocouple as some examples.

The method 600 includes determining 604 whether the workpiece is at a target temperature. The workpiece target temperature determining 604 may include, for example, comparing the measured temperature of the workpiece to a baseline value and/or comparing the temperature of the workpiece to a predicted value based on an expected cooling or heating rate for a given time period.

If the workpiece is not at the target temperature, the method 600 may include adjusting 604 the additive head 20 so that the laser emitted from the optical head 42 is diffused when the laser contacts the workpiece. For example, the adjusting 604 may include adjusting the position of the additive head 20 so that the optical head 42 is sufficiently far away from the workpiece that the laser emitted from the optical head 42 is diffused when the laser contacts the workpiece. For example, the adjusting 604 may include positioning the additive head 20 six to eight inches away from the workpiece. Alternatively or additionally, the adjusting 604 may include decreasing the power of the laser emitted from the optical head 42.

The method 600 includes heating 606 the workpiece using the diffused laser. Due to the optical head 42 being positioned to illuminate the workpiece with a diffused laser, the diffused laser heats the workpiece rather than melting the workpiece. For example, more light from the optical head 42 is redirected off of the substrate than when the optical head 42 is positioned to melt the substrate such that the energy of the light is insufficient to melt the substrate.

The method 600 includes measuring 602 the temperature of the workpiece and repeating the process until the workpiece is at the desired temperature 604. The processor 82 may continue to monitor the temperature of the workpiece and initiate the method 600 in response to the temperature of the workpiece deviating from the target temperature.

The method 600 permits heat treating of a workpiece using the diffused laser rather than having to have a separate oven to heat the workpiece. The heat treating may include, for example, annealing of a workpiece. Further, the method 600 allows the hybrid machine tool 10 to raise the temperature of a workpiece to a temperature that may be desirable for hot wire welding simply by using the diffused laser rather than requiring an operator to separately heat the substrate in an oven.

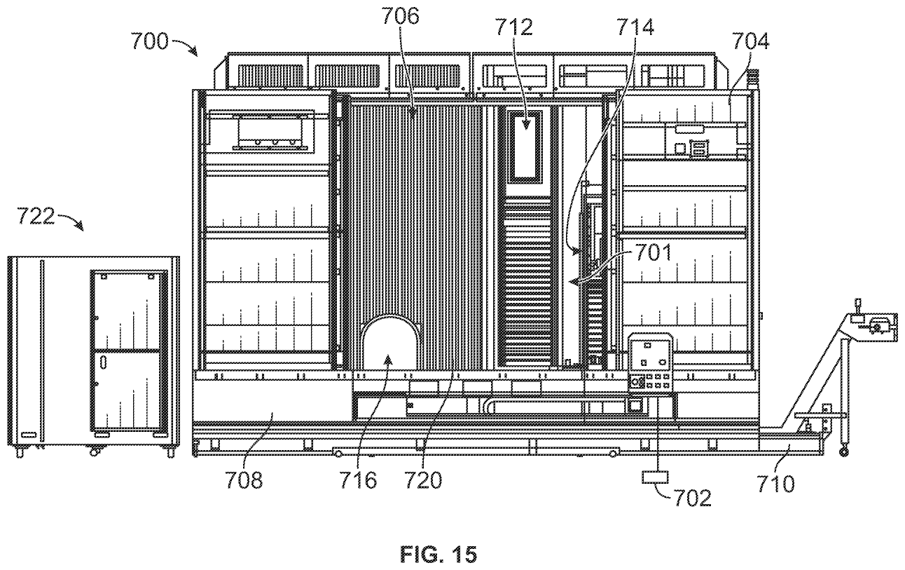

Referring to FIG. 15, a hybrid machine tool 700 is provided that is similar in many respects to the hybrid machine tool 10 discussed above. For example, the hybrid machine tool 700 has a hot wire welding apparatus 701 similar to the hot wire welding apparatus 40 discussed above, a cover lens assist gas circuit similar to the cover lens assist gas circuit 99 discussed above, and a frame assembly with drives that include ball screws, servomotors, and encoders. Further, the hybrid machine tool 700 is operable to perform the method 600 discussed above. Another similarity is that the hybrid machine tool 700 includes an optical head 736. In one embodiment, the optical head 736 has temperature sensors that detect temperatures at different portions of the optical head 736 and a controller of the hybrid machine tool 700 compares the detected temperatures against different thresholds for the different portions of the optical head 736 to determine whether the optical head 736 is overheating. Any further discussion of similar structures and operations of the hybrid machine tools 10, 700 will be limited for brevity purposes.

The machine tool 700 includes a controller 702 that is capable of performing operations similar to those discussed above with respect to the hybrid machine tool 10. The hybrid machine tool 700 includes a housing 704 enclosing a work room 706 with a partition 720, a base 708 supporting the housing 704, and a lower frame 710 that may be connected to a conveyance (e.g., a vehicle) for movement of the hybrid machine tool 700. The hybrid machine tool 700 includes an additive head 712, a spindle head 714, and a table 716. The hybrid machine tool 700 has a partition 720 that separates the work room 706 from components of the hybrid machine tool 700. The hybrid machine tool 700 further includes an additive system enclosure 722 that houses components used for operation of the additive head 712.

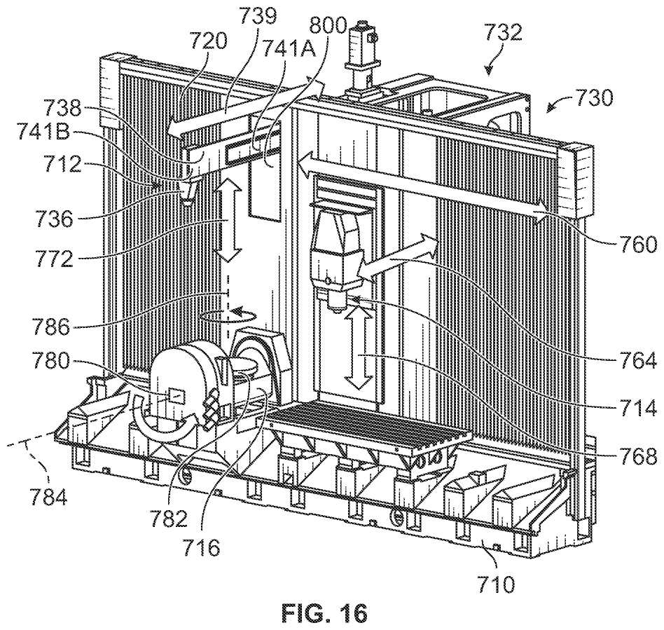

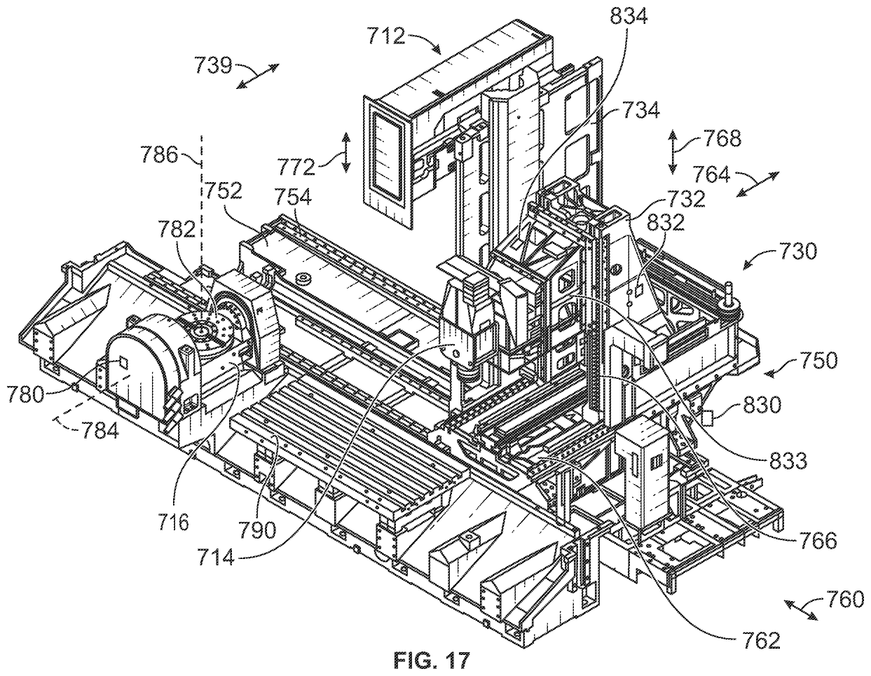

Referring to FIGS. 16 and 17, the hybrid machine tool 700 has a frame assembly 730 including a vertical spindle column 732 including the spindle head 714 and a vertical additive head column 734 including the additive head 712. The additive head 712 includes an optical head 736 and an arm 738 that permits shifting of the optical head 736 in opposite directions along a horizontal Y2-axis 739. The optical head 736 is movable along the Y2-axis 739 independent of the spindle head 714, unlike the spindle head 18 and additive head 20 of the hybrid machine tool 10 which travel together along the horizontal Y-axis 126 (see FIG. 3).

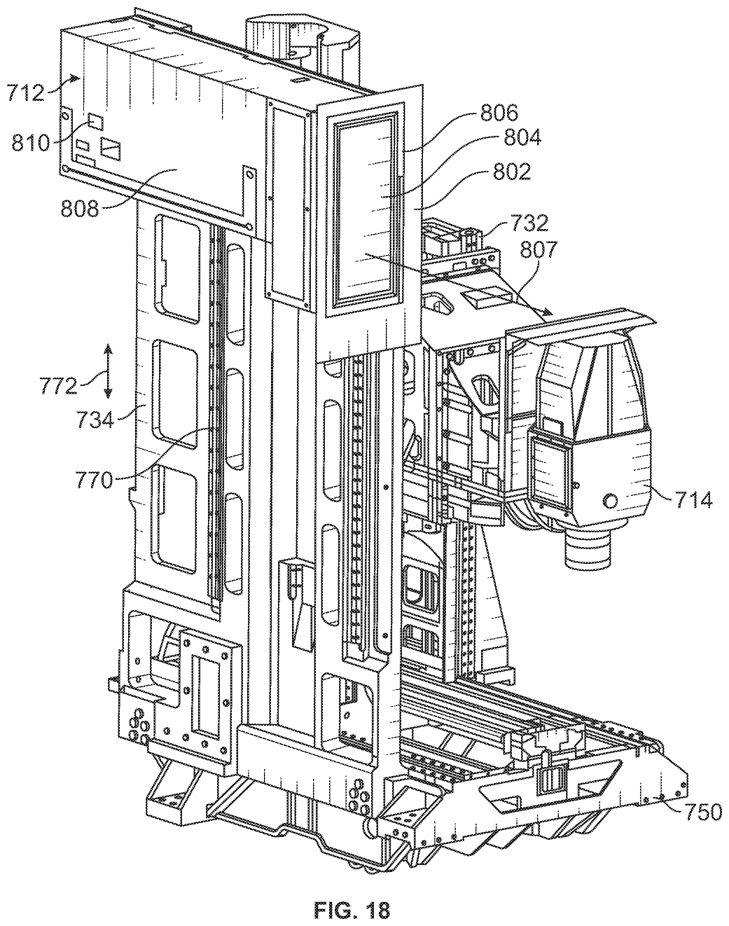

The frame assembly 730 includes an intermediate frame, such as a saddle 750, and a base frame 752. The saddle 750 and base frame 752 have one or more slide connections, such as linear guides 754, that permit movement of the saddle 750 along a horizontal X-axis 760 orthogonal to the Y2-axis 739. The spindle column 732 and saddle 750 include one or more slide connections, such as linear guides 762, that permit movement of the spindle column 732 along a horizontal Y1-axis 764 parallel to the Y2 axis 739 and orthogonal to the X-axis 764. The spindle head 714 includes one or more slide connections with the spindle column 732 such as linear guides 766 that permit shifting of the spindle head 714 along a vertical Z1-axis 768 orthogonal to the Y1-axis 764, the Y2-axis 739, and the X-axis 764. As can be seen in FIG. 18, the additive head 712 and additive head column 734 include one or more slide connections, such as linear guides 770, that permit the additive head 712 to shift along a vertical Z2-axis 772 that is parallel to the vertical Z1-axis 768 and orthogonal to the Y1-axis 764, the Y2-axis 739, and the X-axis 764.

Returning to FIG. 17, the table 716 includes a table drive 780 operable to turn a table top 782 of the table 716 about a B-axis 784 and turn the table top 782 about a C-axis 786 extending perpendicular to the B-axis 784. The table drive 780 includes one or more motors. The frame assembly 730 further includes a fixed platform 790 upon which a workpiece may be supported.

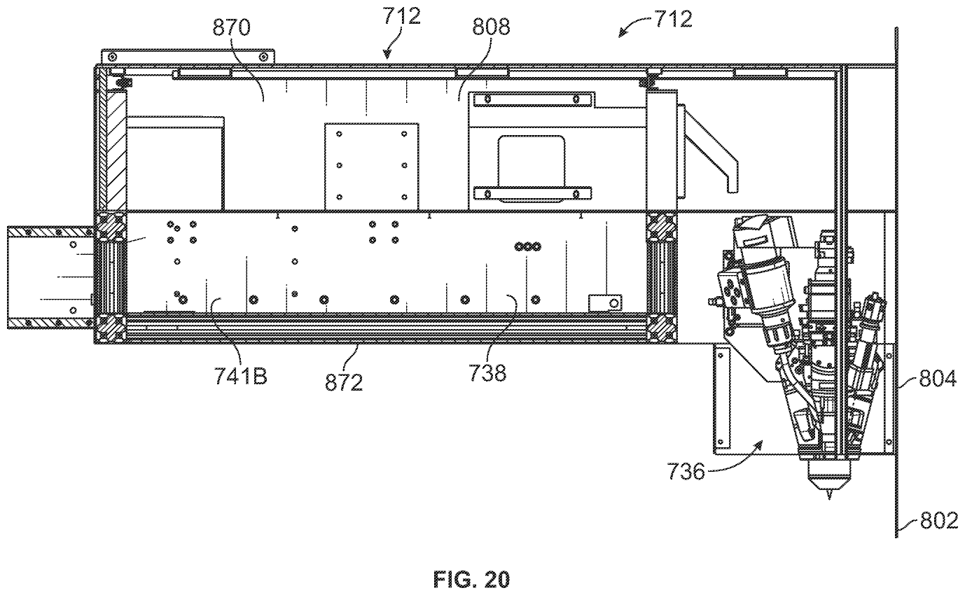

Continuing reference to FIGS. 16 and 18, the partition 720 includes an opening 800 and the additive head 712 includes a flange 802 that fits in the opening 800 and a cover 804 which closes an opening 806 of an additive head housing 808 around which the flange 802 extends. The cover 804 and housing 808 cooperate to form an optical head compartment 803 for protecting the optical head 736 when not in use. The flange 802 fills in any gaps between the compartment and the partition 720. The additive head 712 includes a drive 810 operable to move telescoping portions 741A, 741B of the arm 738 from a retracted to an extended position which shifts the cover 804 and the optical head 736 (see also FIG. 20) outward from the flange 802 in direction 807 to position the optical head 736 in an operative position in the work room 706 relative to the table 716, partition 720, and/or fixed support 790. In one embodiment, the drive 810 includes a servomotor, ball screw, and encoder. The servomotor turns the ball screw to extend or retract the telescoping portions 741A, 741B and linear bearings guide the telescoping portions 741A, 741B.

As can be seen in FIG. 17, the frame assembly 730 includes a saddle drive 830 configured to shift the saddle 750 along the X-axis 760. The spindle column 732 includes a spindle column drive 832 operable to shift the spindle column 732 along the Y1-axis 764. The spindle head 714 further includes a spindle head frame 833 and a motor 852 operable to rotate a spindle 854 of the spindle head 714, the motor 852 being mounted to the spindle head frame 833. The spindle head 714 also has a spindle head drive 834 operable to shift the spindle head frame 833 and motor 852 along the Z1-axis 768. With reference to FIG. 18, the additive head drive 810 may also be configured to shift the additive head 712 along the Z2-axis 772. In one embodiment, the additive head drive 810 includes a first motor to drive the arm portions 741A, 741B between the retracted and extended positions and a second motor to drive the housing 808 supporting the optical head 736 along the Z2-axis 772.

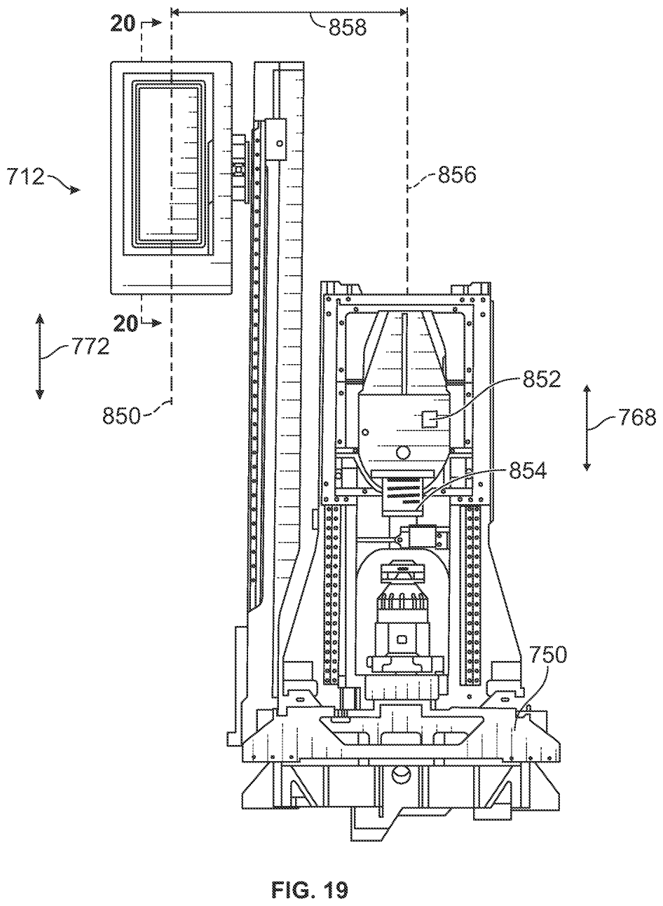

Referring to FIG. 19, the optical head 736 of the additive head 712 is configured to direct a laser along an axis 850 and the spindle head 714 includes the motor 852 operable to rotate the spindle 854 of the spindle head 714 about an axis 856. The axes 850, 856 are separated by a lateral offset 858.

Regarding FIG. 20, the additive housing 808 is shown with the arm portions 741A, 74B in a retracted position and the optical head 736 in a stored position relative to the table 716, partition 720, and/or fixed support 790. With the arm portions 741A, 741B in the retracted position, the arm sections 741A, 741B are side-by-side and disposed at least partially in the housing 808. The housing 808 further includes one or more walls 870 and an internal frame 872 providing rigidity to the housing 808.

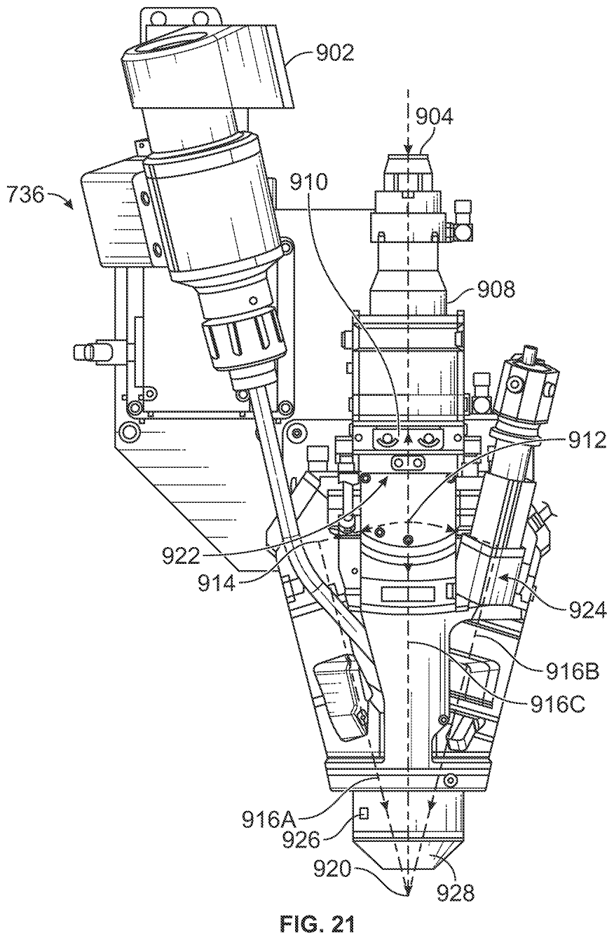

Referring to FIG. 21, the optical head 736 includes a wire feeder 902 for receiving heated wire and directing the wire into a melt pool. The optical head 736 has a beam input 904, a collimator 908, and a focus lens 910. The optical head 736 has a triple splitting mirror 912 configured to split the laser beam into three branches 916A, 916B, 916C and flat adjustable steering mirrors 914. The three beam branches 916A, 916B, 916C converge at a point 920 where the beam branches 916A, 916B, 916C surround the wire and converge directly beneath the wire as the wire enters the melt pool.

The steering mirrors 914 may be adjusted to change the X, Y location for each beam branch and facilitate high-quality weld while the optical head 736 is moving in any direction along the substrate. More specifically, the stability of the additive process is generally dictated by how close to optimal conditions the wire can be pre-heated via current from the power source in relation to how well the substrate can be pre-heated via the laser to form the melt pool. Optimal pre-heat of the wire can be described as supplying current to the wire to reach the nearest point of arcing as possible, without causing the wire to actually spatter or arc. Splitting the laser beam into three branches 916A, 916B, 916C so that the laser beam is able to enter the melt pool without affecting the pre-heat of the wire allows for superior control of the additive process parameters, regardless of direction of travel of the additive head. In one embodiment, the optical head 736 has a power rating of 8 kW.

The optical head 736 has a focus lens drawer 922 configured to facilitate balancing of laser power in each of the three beam branches. To monitor the hot wire welding process, the optical head 736 includes a camera 924. The optical head 736 further includes a nozzle 926 with a shield gas outlet for directing shield gas toward the weld area. The nozzle 926 is integrated in a nosecone 928 of the optical head 736.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, the hybrid machine tools 10, 700 may be operated in a cold wire process, wherein the hybrid machine tools 10, 70 do not heat the wire before welding the wire.

What is claimed is:

1. An additive manufacturing machine comprising:
a wire supply including a wire drive configured to advance a wire at a wire feed rate and a wire heater configured to apply resistive heating to heat the wire;
an additive head for emitting a laser beam to weld the wire to a substrate;
a sensor configured to detect a weld parameter;
a controller operatively connected to the wire supply, additive head, and sensor, the controller being configured to determine a failure mode of the weld as the laser beam welds the wire to the substrate based at least in part upon the weld parameter;
the controller being configured to, in response to determining the failure mode, adjust at least one of the wire feed rate, the resistive heating, and a power of the laser beam as the laser beam welds the wire to stabilize the weld.

2. The additive manufacturing machine of claim 1 wherein the controller is configured to utilize a closed-loop feedback control of the wire supply and additive head as the laser beam welds the wire to the substrate.

3. The additive manufacturing machine of claim 1 wherein the controller is configured to determine whether the weld parameter indicates the failure mode of the weld a plurality of times as the additive head welds the wire to the substrate.

4. The additive manufacturing machine of claim 1 wherein the failure mode determined by the controller comprises any one or more of a plurality of predetermined failure modes including:
excessive arcing;
non-linear wire feed;
sagging of an additive surface; and
inadequate bead penetration into the substrate; and
the controller adjusts the at least one of the wire feed rate, resistive heating, and the power of the laser beam based on the predetermined failure mode.

5. The additive manufacturing machine of claim 1 wherein the sensor comprises an optical sensor and a microphone; and
wherein the weld parameter includes a light parameter and a sound parameter indicative of light and sound emitted as the additive head welds the wire.

6. The additive manufacturing machine of claim 1 wherein the sensor comprises an optical sensor and the weld parameter includes at least one of a color of light and an intensity of light emitted as the laser beam welds the wire;
the controller is configured to determine the failure mode of excessive arcing based upon information from the optical sensor indicating a change of color or intensity of light emitted, or both, has occurred as the laser beam welds the wire; and
in response to determining the failure mode of excessive arcing, the controller decreases power for the wire heater to apply resistive heating to heat the wire.

7. The additive manufacturing machine of claim 1 wherein the sensor includes a camera and the weld parameter includes a wire feed parameter representative of an image captured by the camera;
wherein the controller is configured to determine the failure mode of non-linear wire feed via the wire feed parameter; and
wherein in response to determining the failure mode of non-linear wire feed, the controller decreases the wire feed rate.

8. The additive manufacturing machine of claim 1 wherein the sensor comprises a camera and the weld parameter includes a workpiece dimension parameter representative of an image captured by the camera of the welded wire;
wherein the controller is configured to determine the failure mode of sagging of an additive surface via the workpiece dimension parameter; and
wherein in response to determining the failure mode of sagging of the additive surface, the controller decreases the power for the laser.

9. The additive manufacturing machine of claim 1 wherein the sensor comprises a thermal imaging camera and the weld parameter includes a temperature of the welded wire detected by the thermal imaging camera;
wherein the controller is configured to detect the failure mode of sagging of an additive surface based upon the temperature of the welded wire provided by the thermal imaging camera; and
wherein in response to determining the failure mode of sagging of an additive surface, the controller decreases the power for the laser.

10. The additive manufacturing machine of claim 1 further comprising a drive operatively connected to the controller and the additive head, the controller configured to operate the drive to adjust a height of the additive head and permit the additive head to weld layers of wire;
wherein the controller is configured to determine the failure mode of sagging of an additive surface by detecting a height of the additive head during application of a weld layer that is less than a predetermined height; and
wherein in response to determining the failure mode of sagging of the additive surface the controller decreases power for the laser beam.

11. The additive manufacturing machine of claim 1 wherein the optical sensor comprises a camera and the weld parameter includes a workpiece dimension parameter of the welded wire;
wherein the controller is configured to determine the failure mode of sagging of an additive surface by determining a deviation of the workpiece dimension parameter from a projected workpiece dimension parameter; and
wherein in response to determining the failure mode of sagging of the additive surface the controller decreases the power of the laser beam.

12. The additive manufacturing machine of claim 1 further comprising a spindle head configured to receive and rotate a tool;
wherein the controller is operatively connected to the spindle head and operable to cause the spindle head to machine the welded wire with the tool.

13. The additive manufacturing machine of claim 12 wherein the additive head includes an optical head;
further comprising a frame assembly configured to support the optical head and the spindle head for being shifted along an X axis, the spindle head for being shifted along a Y1 axis perpendicular to the X axis and for being shifted along a Z1 axis perpendicular to the X axis and the Y1 axis, and the optical head for being shifted along a Y2 axis perpendicular to the X axis and a Z2 axis perpendicular to the X axis and the Y2 axis; and
wherein shifting of the optical head along the Y2 axis and the Z2 axis is independent of shifting of the spindle head along the Y1 and Z1 axis.

14. The additive manufacturing machine of claim 1 wherein the additive head includes a plurality of temperature sensors configured to detect temperatures of different predetermined portions of the additive head;
wherein the controller includes a memory storing temperature thresholds for the different predetermined portions of the additive head with the temperature thresholds being different for each of the predetermined portions of the additive head; and
the controller is configured to determine overheating of the additive head in response to any of the temperature sensors detecting a temperature in excess of the temperature threshold for the corresponding predetermined portion of the additive head.

15. The additive manufacturing machine of claim 1 further comprising a user interface operatively connected to the controller, the user interface operable to receive user inputs representative of the wire feed rate, resistive heating, and power for the laser.

16. The additive manufacturing machine of claim 1 wherein the additive head is configured to emit the laser beam at the substrate to form a pool of melted substrate and advance the wire into the pool of melted substrate to weld the wire to the substrate.

17. A hybrid machine tool comprising:
a spindle head configured to receive and rotate a tool for machining a workpiece, the workpiece having predetermined dimensions prior to machining thereof;
a wire supply including a wire drive configured to advance a wire at a wire feed rate and a wire heater configured to apply resistive heating to heat the wire;
an additive head for emitting a laser beam to weld the wire to a substrate and form the workpiece;
a controller operatively connected to the spindle head, wire supply, and the additive head, the controller configured to adjust any of the wire feed rate, the resistive heating, and a power of the laser beam as the laser beam welds the wire to form the workpiece having the predetermined dimensions so that the workpiece can be precisely machined by operation of the spindle head; and
the controller configured to operate the spindle head to machine the workpiece having the predetermined dimensions via rotation of the tool.

18. The hybrid machine tool of claim 17 wherein the controller is configured to interleave the additive head forming layers of the workpiece with the spindle head machining layers of the workpiece.

19. The hybrid machine tool of claim 17 wherein the controller is operable to cause the additive head to form a first portion of the workpiece, cause the spindle head to machine the first portion of the workpiece, and cause the additive head to form a second portion of the workpiece on the machined first portion of the workpiece.

20. The hybrid machine tool of claim 17 further comprising a user interface operatively connected to the controller, wherein the controller is configured to adjust any of the wire feed rate, resistive heating, and the power of the laser beam as the laser beam welds the wire in response to the user interface receiving a user input providing an adjusted parameter for at least one of the wire feed rate, resistive heating, or power of the laser beam.

21. The hybrid machine tool of claim 17 further comprising a user interface operatively connected to the controller, the user interface configured to receive a user input indicative of initial parameters for the wire feed rate, resistive heating, and power for the laser; and
wherein the controller is configured to adjust any of the wire feed rate, the resistive heating, and a power of the laser beam as the laser beam welds by changing at least one of the initial parameters for the wire feed rate, resistive heating, and power for the laser to an adjusted parameter.

22. The hybrid machine tool of claim 17 further comprising a sensor configured to detect a weld parameter; and
wherein the controller is operatively connected to the sensor and configured to determine a failure mode of the weld as the laser beam welds the wire to the substrate based at least in part upon the weld parameter; and
wherein the controller is configured to, in response to determining the failure mode, adjust at least one of the wire feed rate, resistive heating, and the power of the laser beam as the laser beam welds the wire to stabilize the weld.

23. The hybrid machine tool of claim 22 wherein the failure mode determined by the controller comprises any one or more of a plurality of predetermined failure modes including:
excessive arcing;
non-linear wire feed;
sagging of an additive surface;
inadequate bead penetration into the substrate; and
the controller adjusts the at least one of the wire feed rate, resistive heating, and the power of the laser beam based on the predetermined failure mode.

24. The hybrid machine tool of claim 22 wherein the sensor comprises an optical sensor and a microphone; and
wherein the weld parameter includes a light parameter and a sound parameter indicative of light and sound emitted as the additive head welds the wire

25. The hybrid machine tool of claim 17 wherein the additive head includes an optical head;
further comprising a frame assembly configured to support the optical head and the spindle head for being shifted along an X axis, the spindle head for being shifted along a Y1 axis perpendicular to the X axis and for being shifted along a Z1 axis perpendicular to the X axis and the Y1 axis, and the optical head for being shifted along a Y2 axis perpendicular to the X axis and a Z2 axis perpendicular to the X axis and the Y2 axis;
wherein shifting of the optical head along the Y2 axis and the Z2 axis is independent of shifting of the spindle head along the Y1 and Z1 axis.

26. The hybrid machine tool of claim 17 wherein the wherein the additive head is configured to emit the laser beam at the substrate to form a pool of melted substrate and advance the wire into the pool of melted substrate to weld the wire to the substrate.

27. A hybrid machine tool comprising:
a spindle head having a spindle configured to receive a tool, the spindle head operable to rotate the rotate the spindle and tool received therein;
a wire supply to advance a wire toward a substrate;
an optical head configured to emit a laser beam to weld the wire to the substrate;
a frame assembly configured for supporting the spindle head and the optical head for being driven along multiple transverse axes including an X axis;
the frame assembly configured for supporting the spindle head to be driven along a Y1 axis perpendicular to the X axis and along a Z1 axis perpendicular to the X axis and the Y1 axis;
the frame assembly configured for supporting the optical head to be driven along a Y2 axis parallel to the Y1 axis and perpendicular to the X axis independently of driving the spindle head along the Y1 axis;
the frame assembly configured for supporting the optical head to be driven along a Z2 parallel to the Z1 axis and perpendicular to the X axis and the Y2 axis independently of driving the spindle head along the Z1 axis;
the spindle head and the optical head having respective bodies with the spindle head body larger than the optical head body at least along the Y1 and Y2 axes and Z1 and Z2 axes with the independent driving of the optical head relative to the spindle head along Y2 and Z2 axes allowing the optical head to be driven farther distances along the Y2 and Z2 axes than the spindle head is driven along the Y1 and Z1 axes, respectively;
a controller operatively connected to the spindle head, wire supply, optical head, and frame assembly and being operable to cause the optical head to be selectively driven along the multiple axes for producing a workpiece via the optical head welding the wire;
the controller further being operable to rotate the spindle for machining the workpiece with the tool.

28. The hybrid machine tool of claim 27 further comprising a workpiece table to support the workpiece formed using the optical head;
wherein the workpiece table is rotatable about a B-axis extending perpendicular to the X axis;
wherein the workpiece table is rotatable about a C-axis extending perpendicular to the B-axis; and
wherein the controller is operable to shift the spindle head along at least one of the Y1 and Z1 axes away from the workpiece table independent of driving of the optical head along the Y2 and Z2 axis to provide space for the optical head to form the workpiece on the table.

29. The hybrid machine tool of claim 27 wherein the frame assembly includes a base frame and an intermediate frame, and the spindle head and optical head are supported by the intermediate frame;
wherein the frame assembly includes a first slide connection between the base frame and the intermediate frame that permits movement of the intermediate frame and spindle head and optical head supported thereby along the X axis.

30. The hybrid machine tool of claim 29 wherein the frame assembly includes a spindle head column supporting the spindle head, the spindle head column and the intermediate frame having a second slide connection therebetween that permits the spindle column and spindle head supported thereby to shift along the Y1 axis; and
wherein the frame includes an additive head column fixed relative to the intermediate frame and an additive head frame connecting the optical head to the additive head column, the additive head frame having a third slide connection that permits the optical head to shift along the Y2 axis.

31. The hybrid machine tool of claim 30 wherein the frame comprises a spindle head frame supporting the spindle head and a fourth slide connection between the spindle head frame and the spindle head column that permits the spindle head frame and spindle head supported thereby to shift along the Z1 axis; and
wherein the additive head frame and additive head column have a fifth slide connection therebetween that permits the additive head frame and optical head supported thereby to shift along the Z2 axis.

32. The hybrid machine tool of claim 30 wherein the additive head frame comprises an arm having portions and the third slide connection slidably connects the arm portions.

33. The hybrid machine tool of claim 27 wherein the frame assembly comprises a base frame, an intermediate frame shiftable along the X axis relative to the base frame, an additive head column supported by the intermediate frame, and an additive head frame interconnecting the optical head and the additive head column;
wherein the additive head frame and the additive head column have a slide connection therebetween permitting shifting of the optical head along the Z2 axis relative to the additive head column; and
wherein the additive head frame includes an optical head drive operable to shift the optical head along the Y2 axis.

34. The hybrid machine tool of claim 33 wherein the additive head frame comprises a compartment having a closed configuration wherein the optical head is in the compartment and an open configuration wherein the optical head is outside of the compartment; and
the optical head drive shifts the compartment between the closed configuration and the open configuration with shifting of the optical head along the Y2 axis.

35. The hybrid machine tool of claim 27 wherein the optical head is configured to receive laser light and focus the laser light into a laser beam, the optical head including a splitting mirror to split the generated laser beam into a plurality of laser beam branches and adjustable mirrors to direct the laser beam branches to converge at a point for welding the wire.

36. The hybrid machine tool of claim 27 wherein the wire supply includes a wire drive and a wire heater, the wire heater configured to apply a voltage and current to the wire to heat the wire via resistive heating.

37. A hybrid machine tool comprising:
a spindle head configured to receive and rotate a tool to machine a workpiece;
a wire supply to advance a wire for being welded to a substrate;
an additive head configured to emit a laser beam to weld the wire to the substrate;
an air source;
a shield gas source;
a valve operatively connected to the additive head, the air source, and the shield gas source, the valve having a first configuration wherein the valve directs air from the air source toward the additive head to protect the additive head from debris produced during machining of the workpiece and a second configuration wherein the valve directs shield gas from the shield gas source toward the additive head to provide a predetermined atmosphere for welding the wire; and
a controller operatively connected to the additive head and the valve, the controller configured to shift the valve from the first configuration to the second configuration upon operation of the additive head, the controller configured to shift the valve from the second configuration to the first configuration upon a termination of the operation of the additive head.

38. The hybrid machine tool of claim 37 wherein the valve comprises an air solenoid and a shield gas solenoid;
wherein the air solenoid is open and the shield gas solenoid is closed with the valve in the first configuration; and
wherein the air solenoid is closed and the shield gas solenoid is open with the valve in the second configuration.

39. The hybrid machine tool of claim 37 wherein the additive head comprises an optical head having a laser outlet to emit the laser and a compartment, the compartment having a closed configuration wherein a portion of the compartment covers the laser outlet to protect the laser outlet from machining debris and an open configuration wherein the compartment portion is clear of the laser outlet and permits the laser outlet to emit the laser to weld the wire.

40. The hybrid machine tool of claim 39 wherein the additive head includes an air passageway configured to direct air from the valve into the compartment to provide air to the compartment and provide positive air pressure in the compartment which keeps debris away from the optical head when the compartment is in the closed configuration.

41. The hybrid machine tool of claim 37 wherein the additive head includes an optical head having an outlet tube to direct the laser beam downwardly to weld the wire, the optical head having a cover lens and a compartment above the cover lens; and
wherein the additive head includes an air passageway connected to the valve, the air passageway directing air from the valve to the compartment above the cover lens to resist the ingress of debris toward the cover lens.

42. The hybrid machine tool of claim 37 wherein the additive head includes a shield gas outlet in communication with the valve, the shield gas outlet configured to direct shield gas toward the wire being welded by the laser beam so that oxygen content in the area encompassed by the shield gas is below 1% free oxygen concentration.

43. The hybrid machine tool of claim 37 further comprising a user interface operatively connected to the controller, the user interface operable to receive user inputs to set an initial laser power, a shield gas flow rate, and a wire feed rate.

44. The hybrid machine tool of claim 37 wherein the wire supply comprises a wire drive and a wire heater, the wire drive configured to provide wire to the additive head at a wire feed rate, the wire heater configured to apply a voltage and current to the wire to heat the wire via resistive heating.

45. The hybrid machine tool of claim 37 wherein the air source comprises a compressed air line; and
wherein the shield gas source comprises an argon gas source.

46. The hybrid machine tool of claim 37 wherein the valve has a third configuration wherein the valve inhibits the flow of air and shield gas toward the additive head.

47. A hybrid machine tool comprising:
a spindle head configured to receive and rotate a tool;
a temperature sensor to measure a temperature of a substrate;
a wire supply to provide a wire;
an additive head configured to emit a first laser to weld the wire to the substrate;
a controller operatively connected to the spindle head, temperature sensor, wire supply, and additive head, the controller configured to:
determine whether the temperature of the substrate is at a target temperature based on the temperature of the substrate measured by the temperature sensor;
adjust the additive head to emit a second laser having a greater diffusion on the substrate than the first laser upon the temperature of the substrate not being at the target temperature; and
cause the additive head to emit the second laser and heat the substrate to the target temperature.

48. The hybrid machine tool of claim 47 wherein to adjust the additive head to emit the diffused laser comprises the controller adjusting a position of an optical head of the additive head so that the optical head is a predetermined distance away from the substrate.

49. The hybrid machine tool of claim 47 wherein the additive head comprises an optical head; and
wherein to adjust the additive head to emit the diffused laser comprises the controller decreasing a laser power of a laser emitted by the optical head.

50. The hybrid machine tool of claim 47 wherein the temperature sensors comprises at least one of a camera, an infrared thermometer, and a thermocouple.

51. The hybrid machine tool of claim 47 wherein to determine whether the temperature of the substrate is at the target temperature comprises the controller comparing the measured temperature and the target temperature.

52. The hybrid machine tool of claim 47 wherein to determine whether the temperature of the substrate is at the target temperature comprises the controller:
determining a predicted temperature based upon the measured temperature; and
comparing the predicted temperature and the target temperature.

53. The hybrid machine tool of claim 47 wherein to determine whether the temperature is at the target temperature comprises the controller determining whether the temperature is equal to or greater than the target temperature.

54. A method of heating a substrate using a hybrid machine tool having an additive head and a spindle head, the spindle head configured to receive and rotate a tool, the method comprising:
measuring a temperature of a substrate;
determining whether the substrate is at a target temperature;
adjusting the additive head of the hybrid machine tool to emit a diffused laser at the substrate upon the temperature of the substrate not being at the target temperature;
causing the additive head to emit the diffused laser to heat the substrate to heat the substrate to the target temperature; and
causing the additive head to emit a welding laser that has a reduced diffusion on the substrate than the diffused laser to melt the substrate upon the substrate reaching the target temperature.

55. The method of claim 54 wherein adjusting the additive head of the machine tool to emit the diffused laser comprises adjusting a position of an optical head of the additive head so that the optical head is a predetermined distance away from the substrate.

56. The method of claim 54 wherein adjusting the additive head of the machine tool to emit the diffused laser comprises decreasing a laser power of a laser emitted by an optical head of the additive head.

57. The method of claim 54 wherein measuring the temperature of the substrate comprises measuring the temperature of a substrate that has been secured to a table of the hybrid machine tool.

58. The method of claim 54 wherein measuring the temperature of the substrate comprises measuring the temperature of the substrate using at least one of a camera, an infrared thermometer, and a thermocouple.

59. The method of claim 54 wherein determining whether the substrate is at the target temperature comprises comparing the measured temperature and the target temperature.

60. The method of claim 54 wherein determining whether the substrate is at the target temperature comprises:
determining a predicted temperature based upon the measured temperature; and
comparing the predicted temperature and the target temperature.
